(19) United States
(12) Patent Application Publication
(10) Pub. No.: US 2026/0351932 A1
(43) Pub. Date: Nov. 5, 2026

(54) COMPACT AUTOMATED CABLE PREPARATION DEVICE

(71) Applicants: 3M Innovative Properties Company, St. Paul, MN (US); Connected Intelligence Systems Ltd., Netanya (IL)

(72) Inventors: Douglas B. Gundel, Cedar Park, TX (US); Sally Moya Grambusch, Round Rock, TX (US); Ido Stern, Raanana (IL)

(21) Appl. No.: 19/488,349

(22) PCT Filed: May 30, 2024
(86) PCT No.: PCT/US2024/031701

§ 371 Date: Nov. 26, 2025

Related U.S. Application Data
(60) Provisional application No. 63/505,214, filed on May 31, 2023.

(51) Int. Cl. H02G 1/12

(52) U.S. Cl. CPC H02G 1/1265; H02G 1/127; H02G 1/1297

(57) ABSTRACT

An example electrical cable preparation device includes a rotatable tool head including a plurality of rollers and at least one cutting tool The device also includes a depth driver configured to insert into the rotatable tool head to adjust a radial depth of the plurality of rollers or a radial depth of the at least one cutting tool and a housing configured to house the rotatable tool head and to allow the rotatable tool head to rotate about an electrical cable and move axially along the electrical cable. The device also includes a gripper configured to couple the housing to the electrical cable, and the gripper is configured, to prevent the housing from rotating or moving axially relative to the electrical cable. The electrical cable preparation device is configured to remove one or more layers of the electrical cable.

This application claims priority to U.S. Provisional Application No. 63/505,214, filed May 31, 2023, which is incorporated herein by reference in its entirety,

### TECHNICAL FIELD

The present disclosure relates to the field of electrical equipment for power utilities, including power cables and accessories thereof.

### BACKGROUND

Electrical power grids include numerous components for operating in diverse locations and conditions, such as above-ground, underground, underwater, cold-weather climates, hot-weather climates, or other types of locations or climate conditions. A power grid may include thousands of discrete components, such as transformers, electrical cables, cable accessories (e.g., cable splices, terminations, or other accessories to cables), or other components, and a failure in the power grid may be caused by a failure in any single component or a subset of the components. Installation of electrical cables is a manual process prone to errors, which may cause failure in the electrical cable or a cable accessory.

### SUMMARY

The present disclosure describes techniques, devices, and systems for preparing electrical cables to connect to cable accessories for use in a power grid. According to examples of this disclosure, an electrical cable preparation system, including various interconnected modular components, is configured to couple to an electrical cable and to remove one or more layers of the electrical cable, e.g., in preparation for coupling the electrical cable to a cable accessory such as a cable splice body or a termination. In some examples, the electrical cable preparation system comprises an electrical cable preparation device comprising a gripper configured to couple the device to the electrical cable, and the electrical cable preparation device is configured to remove one or more layers of the electrical cable without being continuously held and/or guided by an operator or a separate base or support structure. In some examples, the electrical cable preparation system is compact and is configured to be mounted to an electrical cable in a relatively small space or volume, such as an electrical cable cabinet.

In one example, this disclosure describes an electrical cable preparation device including: a rotatable tool head including: a plurality of rollers; and at least one cutting tool; a depth driver configured to insert into the rotatable tool head to adjust a radial depth of the plurality of rollers or a radial depth of the at least one cutting tool; a housing configured to house the rotatable tool head and to allow the rotatable tool head to rotate about an electrical cable and move axially along the electrical cable; and a gripper configured to couple the housing to the electrical cable, wherein the gripper is configured to prevent the housing from rotating or moving axially relative to the electrical cable, wherein the electrical cable preparation device is configured to remove one or more layers of the electrical cable.

In another example, this disclosure describes a method including: installing, by an operator, an electrical cable preparation device onto an electrical cable; and removing, but the electrical cable preparation device, a layer of the electrical cable, wherein the electrical cable preparation device comprises: a rotatable tool head including: a plurality of rollers; and at least one cutting tool; a depth driver configured to insert into the rotatable tool head to adjust a radial depth of the plurality of rollers or a radial depth of the at least one cutting tool; a housing configured to house the rotatable tool head and to allow the rotatable tool head to rotate about an electrical cable and move axially along the electrical cable; and a gripper configured to couple the housing to the electrical cable, wherein the gripper is configured to prevent the housing from rotating or moving axially relative to the electrical cable.

In another example, this disclosure describes an electrical cable preparation system configured to remove one or more layers of an electrical cable, the electrical cable preparation system including: a rotatable tool head includes a plurality of rollers; and at least one cutting tool; a depth driver configured to insert into the rotatable tool head to adjust a radial depth of the plurality of rollers or a radial depth of the at least one cutting tool; a housing configured to house the rotatable tool head and to allow the rotatable tool head to rotate about an electrical cable and move axially along the electrical cable; and a gripper configured to couple the housing to the electrical cable, wherein the gripper is configured to prevent the housing from rotating or moving axially relative to the electrical cable; and a computing device comprising processing circuitry configured to: position the rotatable tool head of the electrical cable preparation device at an end of an electrical cable; adjust a radial depth of at least one cutting tool of the rotatable tool head to a preprogrammed cutting depth; and rotate the rotatable tool head with the at least one cutting tool at the predetermined cutting depth.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A is a block diagram illustrating various example components of an electrical power system, such as an electrical power grid, including electrical cables and cable accessories, in accordance with this disclosure,

FIG. 1B is a diagram depicting an example electrical cable preparation system for preparing electrical cables for use within an electrical power system, in accordance with this disclosure.

FIG. 2 is a diagram of an example of the electrical cable preparation system of FIG. 1B, in accordance with this disclosure.

FIG. 3A is a perspective view of an example electrical cable preparation device, in accordance with this disclosure.

FIG. 3B is a transparent perspective view of the example electrical cable preparation device of FIG. 3A, in accordance with this disclosure.

FIG. 3C is an internal perspective view of the example electrical cable preparation device of FIGS. 3A and 3B, in accordance with this disclosure.

FIGS. 4A and 4B are perspective views of another example electrical cable preparation device, in accordance with disclosure.

FIGS. 4C and 4D are perspective views of another electrical cable preparation device, in accordance with this disclosure.

FIG. 4C is a cut-away perspective view of the example electrical cable preparation device of FIGS. 4A and 4B, in accordance with this disclosure.

FIGS. 5A and 5B are perspective views of an example electrical cable preparation device coupled to an electrical cable at an electrical cable cabinet, in accordance with this disclosure.

FIGS. 5C and 5D are perspective views of an example electrical cable preparation device coupled to an electrical cable within an electrical cable cabinet, in accordance with this disclosure.

FIG. 6A is a flow chart of an example method of preparing an electrical cable using a cable preparation device, in accordance with various techniques of this disclosure.

FIG. 6B a conceptual diagram illustrating details of an example technique of preparing an example electrical cable using a cable preparation device, in accordance with various techniques of this disclosure.

FIG. 6C a conceptual diagram illustrating details of an example technique of preparing an example electrical cable using a cable preparation device, in accordance with various techniques of this disclosure.

FIG. 7 is a diagram of an example rotating-head assembly of an example electrical cable preparation device in accordance with this disclosure.

FIG. 8A is a diagram of an example insulation-blade-holder mechanism of an example electrical cable preparation device, in accordance with this disclosure.

FIG. 8B is a diagram of an example insulation-screen-blade-holder mechanism of an example electrical cable preparation device, in accordance with this disclosure.

FIG. 9A is a diagram of an example jacket-and-insulation blade of an example electrical cable preparation device in accordance with this disclosure.

FIG. 9B is a diagram depicting an example jacket-and-insulation blade of an example electrical cable preparation device as used for removing an electrical-cable jacket layer, in accordance with this disclosure.

FIG. 10 is a diagram of an example screwdriver assembly of an example electrical cable preparation device, in accordance with this disclosure.

FIGS. 11A, 11D, and 11G are profile views of an example screwdriver-and-camshaft assembly of an example electrical cable preparation device, in accordance with this disclosure.

FIG. 11B, 11E, and 11H are side views of an example screwdriver-and-camshaft assembly of an example electrical cable preparation device, in accordance with this disclosure.

FIGS. 11C, 11F, and 11I are frontal views of an example screwdriver-and-camshaft assembly of an example electrical cable preparation device, in accordance with this disclosure.

FIGS. 12A and 12B show a profile view and an exploded view, respectively, of an example direct-drive mechanism of an example electrical cable preparation device, in accordance with this disclosure.

FIG. 13 is a diagram of an example interface-and-control module (ICM) of a cable-preparation system, in accordance with this disclosure.

FIG. 14 is a diagram of an example screen display of the ICM of FIG. 14A, in accordance with this disclosure.

FIGS. 15A-15C are conceptual diagrams illustrating example methods for using an example cable-imaging-and-measurement device, in accordance with various techniques of this disclosure.

FIG. 16 is an illustrative diagram depicting an example graphical user interface (GUD) that may be generated by, or used in conjunction with, the cable-imaging-and-measurement device of FIGS. 15A-15C, in accordance with this disclosure.

It is to be understood that the embodiments may be utilized, and structural changes may be made without departing from the scope of the invention. The figures are not necessarily to scale. Like numbers used in the figures refer to like components. However, it will be understood that the use of a number to refer to a component in each figure is not intended to limit the component in another figure labeled with the same number.

### DETAILED DESCRIPTION

Installation of cable accessories often includes preparation of a cable end by removing layers at a correct length and depth to manage electrical stresses. The cable end may become an integral part of the completed cable termination, splice, or separable connector. The cable-preparation step can be very time consuming, often lasting for more than half of the duration of the entire installation process for splices, and cable-preparation must be done correctly and precisely to avoid defects otherwise potentially leading to failure (e.g., arcing and permanent fault) of the cable system at the accessory.

Common defects in electrical cables may include stray knife cuts into the insulation, incorrect cutbacks for the particular cable and accessory, remaining insulation screen (e.g., semi-conductive polymer) on the cable insulation, spurs, or nicks at the transition from the cable insulation to the insulation screen (e.g., semi-conductive layer), contamination on the insulation surface, and the like. In some cases, these insulation defects can be nullified by using grease or compound to fill the defects and displace air. However, installers may neglect or forget this step. Other concerns that can increase the risk of defects and the time required for installation might include less-experienced installers and complicated, general-purpose instructions instead of specific instructions directed to the particular accessory, connector, and/or cable at hand.

In accordance with systems and techniques disclosed herein, an electrical cable preparation system may be configured to automatically and quickly prepare cable ends, rather than using a manual process, and thereby, to reduce defects or otherwise make the resulting termination, splice, or separable connection more resistant to failure. The system can be configured to be able to carry out many critical functions of cable preparation with little intervention, including seamless operator input or automated determination of cutback lengths and depths, real-time defect detection and correction, and the ability to deploy and operate in various field environments, such as the tight constraints of small cabinets. Additionally, the device may be configured to be able to couple to the electrical cable to carry out the functions of cable preparation without continuous support, holding, or guidance by an operator, and to then be removed from the electrical cable.

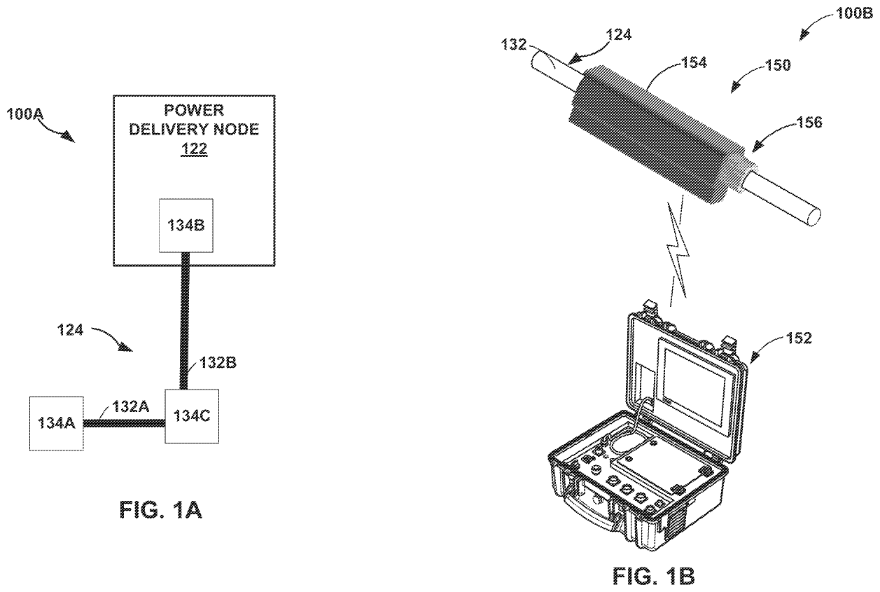

FIG. 1A is a block diagram illustrating various example components of an electrical power system 100A, such as an electrical power grid. As shown in the example of FIG. 1A, system 100A represents a physical environment in which one or more electrical power lines 124 provide power from a power source (e.g., a power plant) to one or more consumers (e.g., businesses, homes, government facilities, etc.). In the example of FIG. 1A, system 100A includes a plurality of articles of electrical equipment, such as one or more power-delivery nodes 122, one or more power lines 124 (including one or more individual electrical cables 132A and 132B (collectively, “electrical cables 132”). and one or more cable accessories 134A-134C (collectively, “cable accessories 134”).

Power-delivery nodes 122 may include one or more input lines to receive electrical power (e.g., directly from a power source or indirectly via another power-delivery node 122) and one or more output lines to directly or indirectly (e.g., via another power-delivery node 122) distribute power to consumers (e.g., homes, businesses, etc.). Power-delivery nodes 122 may include a transformer to step voltages up or step voltages down. In some examples, power-delivery node 122 may be a relatively small node, such as an electrical cabinet, pole-mount transformer, or pad-mount transformer, to distribute power to homes in a neighborhood. As another example, power-delivery node 122 may be a relatively large node (e.g., a transmission substation) distributing power to other power-delivery nodes 122 (e.g., distribution substations), so the other power delivery-nodes further distribute power to consumers (e.g., homes, businesses, etc.).

Power lines 124 may transmit electrical power from a power source (e.g., a power plant) to a power consumer, such as a business or home. Power lines 124 may be underground, underwater, or suspended overhead (e.g., from wooden poles, metal structures, etc.). Power lines 124 may be used for electrical-power transmission at relatively high voltages (e.g., compared to electrical cables typically utilized within a home, which may transmit electrical power between approximately 12 volts and approximately 240 volts depending on application and geographic region). For example, power lines 124 may transmit electrical power above approximately 600 volts (e.g., between approximately 600 volts and approximately 1,000 volts). However, power lines 124 may transmit electrical power over any voltage and/or frequency range. For example, lines 124 may transmit electrical power within different voltage ranges. In some examples, a first type of lines 124 may transmit voltages of more than approximately 1,000 volts, such as for distributing power between a residence or small commercial customer and a power source (e.g., a power utility). As another example, a second type of lines 124 may transmit voltages between approximately 1 kV and approximately 69 kV, such as for distributing power to urban and rural communities, A third type of lines 124 may transmit voltages greater than approximately 69 kV, such as for sub-transmission and transmission of bulk quantities of electric power and connection to very large consumers.

In the example of FIG. 1A, power lines 124 include one or more electrical cables 132 and one or more electrical cable accessories 134A-134C. Electrical cables 132 may also be referred to as “electrical-power cables,” “power cables,” or simply “cables” throughout this disclosure. Electrical cables 132 include a conductor which may be radially surrounded by one or more layers of insulation. In some examples, electrical cable 132 include a plurality of stranded conductors (e.g., a three-phase or multi-conductor cable). Example cable accessories 134 may include splices, separable connectors, terminations, and connectors, among others. In some examples, cable accessories 134 may include cable splices configured to couple (e.g., electrically and physically) two or more electrical cables 132. For example, as shown in FIG. 1A, cable accessory 134C is configured to electrically and physically couple cable 132A to cable 132B. In some examples, terminations may be configured to couple (e.g., electrically and physically) a cable 132 to additional electrical equipment, such as a transformer, switch gear, power substation, business, home, or other structure. For example, as shown in FIG. 1A, cable accessory 134B electrically and physically couples cable 132B to power delivery node 122 (e.g., to a transformer of the power delivery node 122).

FIG. 1B is a diagram depicting an example system 100B for preparing electrical cables for use within electrical power system 100A of FIG. 1A, in accordance with this disclosure. As shown in FIG. 1B, cable preparation system 100B includes at least a cable-preparation device 150 and a computing device 152.

Cable-preparation device 150 may be configured to automatically cut one or more layers of electrical cable 132 (e.g., one of electrical cables 132 of FIG. 1A) to prepare electrical cable 132 for coupling to a cable accessory (e.g., cable accessory 134A of FIG. 1A). Cable-preparation device 150 may be configured to automatically remove various layers (e.g., a jacket layer, a shield layer, an insulation layer, an insulation screen layer, a conductor screen layer, or other layers) of electrical cable 132 as the device cuts the layers. For example, as described in further detail below, cable-preparation device 150 may include one or more cutting tools (e.g., knife blades, saws, etc.) configured to cut the various layers of electrical cable 132.

Cable-preparation device 150 may more-efficiently and more-accurately prepare electrical cable 132 for installation within power line 124 of power system 100A as compared to existing techniques. In some examples, cable-preparation device 150 includes a rotatable tool head. In some examples, the rotatable tool head includes one or more individual cutting tools which may each be configured (e.g., shaped, positioned. and/or oriented) to perform a different “type” of cut (e.g., a scoring cut, a shaving cut, and/or a through cut) into various layers of electrical cable 132 in a selected direction (e.g., longitudinally, radially, and/or circumferentially), and in some examples, remove various layers of electrical cable 132. In one example, the tool head includes a plurality of rollers configured to support electrical cable 132 while one or more cutting tools of the tool head cut the various layers.

In some examples, cable preparation device 150 is configured to couple to electrical cable 132 to carry out the functions of cable preparation without continuous support, holding, or guidance by an operator, and to then be removed from the electrical cable. In the example shown, cable preparation device 150 comprises housing 154 and gripper 156. Gripper 156 may be coupled to housing 154, and gripper 156 may be configured to removably couple cable preparation device 150 to electrical cable 132, e.g., via removably coupling housing 156 to electrical cable 132. Housing 156 may be configured to house the rotatable tool head, and electrical preparation device 150 may be configured to position the rotatable tool head relative to electrical cable 132 so as to enable the rotatable tool head to remove one or more layers of electrical cable 132, and to hold and/or support the rotatable tool head while the rotatable tool head is removing one or more layers of electrical cable 132 without being continuously held and/or guided by an operator or a separate base or support structure. For example, gripper 156 may be configured to prevent the housing from rotating or moving axially relative to electrical cable 132, while housing 154 allows the rotatable tool head to rotate about electrical cable 132 and to move axially along electrical cable 132, without assistance from an operator.

System 100B includes a computing device 152 communicatively coupled to cable-preparation device 150, and computing device 152 may be configured to control operation of cable-preparation device 150. In some examples, computing device 152 controls cable-preparation device 150 to adjust various components of cable-preparation device 150 to cut the various layers of electrical cable 132. In one example, computing device 152 outputs a command causing cable-preparation device 150 to adjust a depth of the plurality of rollers, which may enable the tool head to support electrical cable 132 as the cutting tools cut the various layers of electrical cable 132.

In some examples, computing device 152 outputs various commands to control the starting position of the cutting tools and a cutting distance (e.g., a cutting depth or cutback length) of the cutting tools. In one example, computing device 152 causes the tool head to start cutting at one end of electrical cable 132. In another example, computing device 152 causes the tool head to start cutting a pre-determined distance from the end of the electrical cable 132 to create a retention band of one or more layers of electrical cable 132. The retention band may prevent one or more layers of electrical cable 132 from moving or becoming loose while the tool head cuts the layers of electrical cable 132.

In some scenarios, computing device 152 outputs commands to remove one or more layers of electrical cable 132. In one example, a command causes a cutting tool to penetrate to a selected depth of electrical cable 132 to create a tab within at least one layer of cable 132. Another command causes the cutting tool to partially retract the cutting tool (e.g., to a shallower cutting depth) so the cutting tool may remove one or more exterior layers of electrical cable 132 without cutting one or more interior layers of electrical cable 132.

In this way, computing device 152 may enable cable-preparation device 150 to prepare an electrical cable faster and control the cutting depth and cutback length of cuts to one or more layers of an electrical cable more accurately, than other techniques or approaches. More-accurately cutting the layers of electrical cable 132 may reduce defects in the electrical cable (e.g., in a cable splice). For example, more-accurately cutting the layers may reduce air voids, and hence decrease the probability and/or quantity of partial-discharge events. Reducing the probability and/or quantity of partial-discharge events may decrease the probability of failure events of electrical cable 132 and increase the useful-life expectancy of the electrical cable 132 and/or cable accessories 134. Reducing the probability of failure events may increase the reliability of power grid 100A of FIG. 1A. Further, increasing life expectancy of electrical cable 132 may decrease costs of constructing, operating, and maintaining power grid 100A.

The examples described above and herein have been and will be discussed with respect to computing device 152 for purposes of example only. It is to be understood that the functions described may be implemented by any suitable computing device. Moreover, the term “computing device” is used to refer to any computing platform having one or more processors providing an execution environment for programmable instructions. For example, a computing device may include one or more computers (e.g., servers, desktops, laptops, tablets, smart phones, blade computers, virtual machines, or the like) coupled to, or otherwise in communication with, cable-preparation device 150. As other examples, a computing device may include one or more processors embedded within cable-preparation device 150.

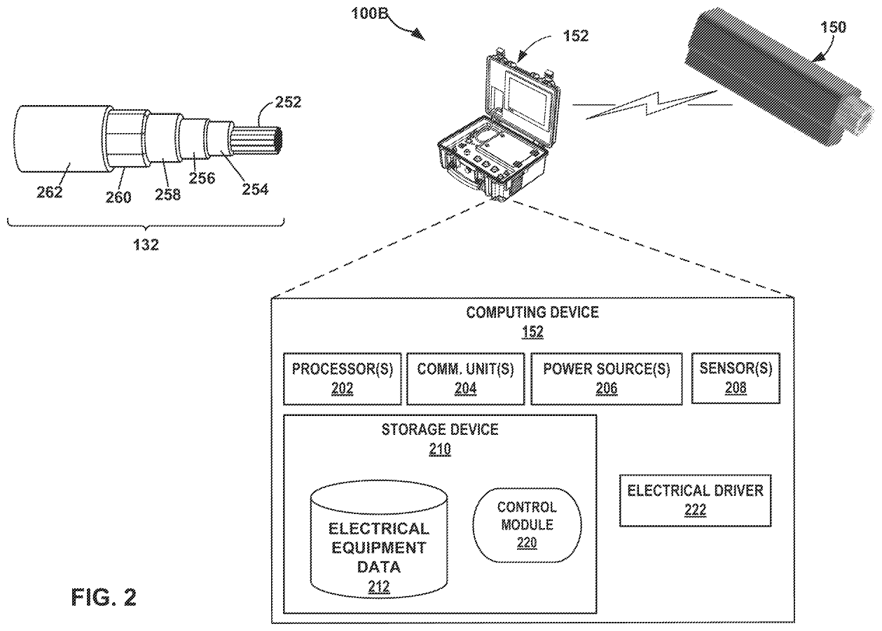

FIG. 2 is an illustrative diagram of some example components of cable-preparation system 100B of FIG. 1B. In the example of FIG. 2, electrical cable 132 includes a plurality of concentric (e.g., cylindrical) layers, such as central conductor 252, conductor screen 254, insulation 256, insulation screen 258, shield 260 (also referred to as “sheath 260”), and jacket 262. However, in some examples, electrical cable 132 may include more or fewer layers. The layers of cable 132 are not necessarily drawn to scale. Electrical cable 132 may be configured for AC and/or DC power transmission.

Electrical cable 132 may be rated to handle voltages of approximately 11 kV, 33 kV, 66 kV, 360 kV, as a few non-limiting example voltages. In some instances, electrical cable 132 transmits electrical power between a power source and a substation by transmitting voltages of 360 kV or more, which may be considered “transmission level” voltages. In some examples, electrical cable 132 is configured to transmit voltages between 33 kV and 360 kV, such as 66 kV or 33 kV, which may be considered “sub-transmission-level” voltages, and may provide electrical power from a power source to an end-operator or customer (e.g., customers utilizing a relatively large amount of power). As another example, electrical cable 132 transmitting electrical power between a distribution substation and a distribution transformer may transmit voltages less than 33 kV, which may be considered “distribution level” voltages. Electrical cable 132 may also transmit electrical power between a distribution substation or distribution transformer (e.g., a pad-mount transformer or pole-mount transformer) and end-operators or consumers (e.g., homes and businesses) and may transmit voltages between 360 volts and 240 volts. At such voltages, electrical cable(s) 132 may be referred to as “secondary distribution lines.”

Central conductor 252 includes a conductive material, such as copper or aluminum. In some examples, central conductor 252 includes a single solid conductor or a plurality of stranded conductors. A diameter or thickness of the central conductor 252 is based on the electrical current that electrical cable 132 is designed to transmit or conduct. In other words, the cross-sectional area of central conductor 252 is based on the electrical current that electrical cable 132 is designed to transmit. For example, central conductor 252 may be configured to transmit electrical currents of 1,000 amperes or more.

Conductor screen 254 may include a semi-conductive polymer, such as a carbon-black-loaded polymer. The semi-conductive polymer may have a bulk resistivity ranging from approximately 5 ohm-cm to approximately 100 ohm-cm. Conductor screen 254 may be physically and electrically coupled to central conductor 252. In the example of FIG. 2, conductor screen 254 is disposed between central conductor 252 and insulation 256. Conductor screen 254 may provide a continuous conductive surface around the exterior of central conductor 252, which may reduce or eliminate sparking otherwise created by central conductor 252.

In some examples, insulation 256 includes polyethylene, such as a cross-linked polyethylene (which may be abbreviated as PEX, XPE, or XLPE) or an ethylene-propylene rubber (which may be abbreviated as EPR). A diameter or thickness of the insulation 256 is based on the voltage electrical cable 132 is designed to transmit or conduct.

Insulation screen 258 may include a semi-conductive polymer-like conductor screen. In the example of FIG. 2, insulation screen 258 is disposed between insulation 256 and shield 260. Insulation screen 258 may be coupled to insulation 256. In some examples, insulation screen 258 is electrically coupled to shield 260. Shield 260 may include a conductive material, such as a metal foil or film or wires, In some examples, shield 260 may be referred to as an “earth ground conductor.”

As illustrated in FIG. 2, jacket 262, also referred to as an “over sheath,” is an outer layer of electrical cable 132. Jacket 262 may be a plastic or rubber polymer, such as polyvinyl chloride (PVC), polyethylene (PE), or ethylene propylene diene monomer (EPDM).

Electrical cable 132 may include additional layers, such as a swellable material or a water-blocking material placed within the conductor strands (e.g., a strand fill) or between various layers within electrical cable 132.

Computing device 152 may include one or more power sources 206 to provide power to components shown in computing device 152. In some examples, power sources 206 include a primary power source to provide electrical power, and a secondary, backup power source to provide electrical power if the primary power source is unavailable (e.g. fails or is otherwise not providing power). In some examples, power source 206 includes a battery, such as a lithium-ion battery.

One or more processors 202 may implement functionality and/or execute instructions within computing device 152. For example, processors 202 may receive and execute instructions stored by storage device 210. These instructions executed by processors 202 may cause computing device 152 to store and/or modify information within storage devices 210 during program execution. In some examples, processors 202 may execute instructions of components to cause control module 220 to perform one or more operations in accordance with techniques of this disclosure. That is, control module 220 may be operable by processor 202 to perform various functions described herein.

One or more communication units 204 of computing device 152 may communicate with external devices by transmitting and/or receiving data. For example, computing device 152 may use communication units 204 to transmit and/or receive radio signals on a radio network such as a cellular radio network. Examples of communication units 204 include a network interface card (e.g. such as an Ethernet card), an optical transceiver, a radio frequency transceiver, or any other type of device sending and/or receiving information. Other examples of communication units 204 may include Bluetooth, cellular (e.g., 3G, 4G), LPWAN, and Wi-Fi® radios. As another example, communications unit 204 may communicate with external devices by transmitting and/or receiving data via wired communication.

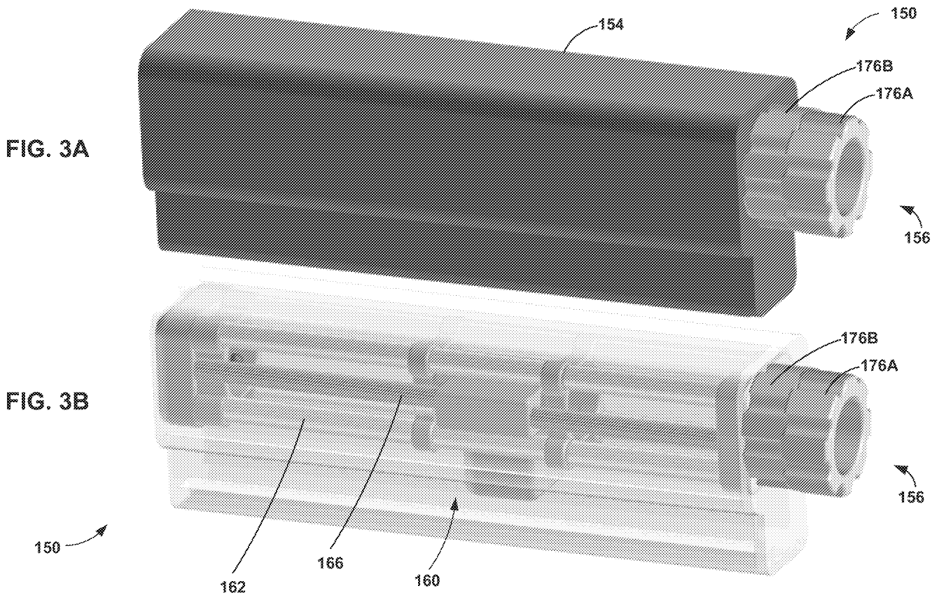

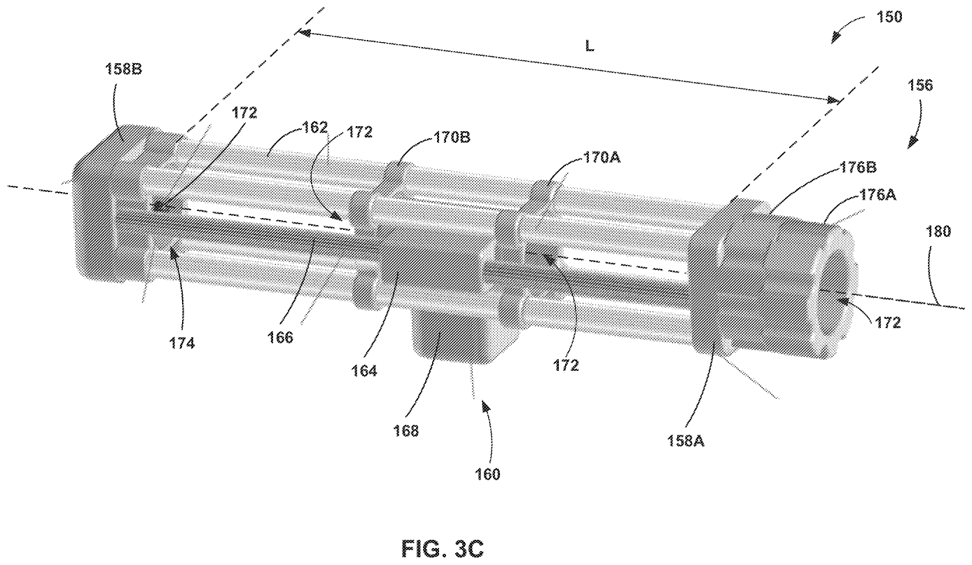

Computing device 152 may include one or more sensors 208. In one example, sensors 208 include one or more position sensors to detect the position of various components of cable preparation-device 150 (e.g., the position of a tool head, rollers, or cutting tools, among others). In another example, sensors 208 may include one or more velocity sensors configured to measure the velocity of various components of cable-preparation device 150. In another example, cable-preparation device 150 can include sensors (e.g., position, velocity, distance, torque, force, etc.) and can communicate sensor readings to computing device 152. In another example, all sensors 208 are located on other modular devices of system 100B, such as those described further below with respect to FIG. 3. Computing device 152 can be connected to sensors 208 through data cables (as shown in FIG. 23A) or wirelessly (as shown in FIGS. 23B and 23C) and computing device 152 interprets the sensor signals. Sensors 208 can be in the modules and feed a local processor controlling motors based on the sensor readings. In other words, encoders can be built into the motor or torque/power feedback from the motors, as discussed in greater detail below. Further any or all of the modular components of the system can have cameras as sensors 208.

In some examples, sensors 208 may include one or more imaging devices, such as a camera or barcode scanner. For example, any or all of cable-preparation device 150, computing device 152, or any of the additional modular components of FIGS. 3A and 3B may include one or more cameras configured to take images of electrical cable 132 before, during, and/or after the layers of electrical cable 132 are cut.

One or more storage devices 210 may store information for processing by processors 202. In some examples, storage device 210 is a temporary memory, meaning that long-term storage is not a primary purpose of storage device 210. Storage device 210 may be configured for short-term storage of information as volatile memory, and therefore, may not retain stored contents if deactivated. Examples of volatile memories include random-access memories (RAM), dynamic random-access memories (DRAM), static random-access memories (SRAM), and other forms of volatile memories known in the art.

Storage device 210 may, in some examples, also include one or more computer-readable storage media. Storage device 210 may be configured to store larger amounts of information than volatile memory. Storage device 210 may further be configured for long-term storage of information as non-volatile memory, e.g., retaining information after or across activated/off cycles. Examples of non-volatile memories include solid-state drives (SSDs), magnetic-storage hard-disk drives (HDDs), flash memories, or forms of electrically programmable memories (EPROM) or electrically erasable and programmable (EEPROM) memories, Storage device 210 may store program instructions and/or data associated with other components, such as control module 220.

In the example of FIG. 2, storage devices 210 include electrical-equipment-data repository 212. Data repository 212 may include relational databases, multi-dimensional databases, maps, hash tables, or any other data structure storing data. In some examples, electrical-equipment-data repository 212 includes device or equipment data, manufacturing data, installation data, consumer data, and/or power-distribution data, among others, For example, electrical-equipment-data repository 212 may include, for each of cable accessories 134 (FIG. 1A), data identifying a date of manufacture, a date of installation, a location (e.g., GPS coordinates, street address, etc.), an entity that installed the cable accessory, a unique identifier (e.g., a serial number), a type of cable accessory, or the like. As another example, electrical equipment data repository 212 may include data indicating cutting dimensions for various types of electrical cables and/or cable accessories.

According to aspects of this disclosure, control module 220 may be operable by one or more processors 202 to functionality of computing device 152 as described herein. For example, control module 220 may output commands to control operation of the cable-preparation device 150. In some examples, control module 220 may also respond to combinations of readings from sensors and stored data, according to programmed logic, by modifying the position or the velocity of physical components in the cable-preparation device, such as cutting tools. In some examples, control module 220 controls cable-preparation device 150 to adjust various components of cable-preparation device 150 to cut the various layers of electrical cable 250. In one example, control module 220 outputs a command causing cable-preparation device 150 to adjust a radial depth of the plurality of rollers, which may enable the tool head to support electrical cable 132 as the cutting tools cut the various layers of electrical cable 132.

In some examples, control module 220 outputs various commands to control the starting position of the cutting tools and a cutting distance (e.g., a cutting depth or cutback length) of the cutting tools. For example, control module 220 may cause the tool head to start cutting at one end of electrical cable 132. In another example, control module 220 may cause the tool head to start cutting a pre-determined distance from the end of electrical cable 132 to create a retention band of one or more layers of electrical cable 132. The retention band may prevent one or more layers of electrical cable 132 from moving or becoming loose while the tool head cuts the layers of electrical cable 132.

In some scenarios, control module 220 outputs commands to remove one or more layers of electrical cable 132. In one example, a command causes a cutting tool to penetrate to a depth of electrical cable 132. Another command partially retracts the cutting tool (e.g., to a shallower cutting depth) so the cutting tool may remove one or more exterior layers of electrical cable 132 without cutting one or more interior layers of electrical cable 132.

In some examples, control module 220 outputs various commands to control gripper 156 to couple to electrical cable 132. For example, control module 220 may cause gripper 136 to tighten or loosen about cable 132 to grip or release cable 132.

Electrical driver 222 may control characteristics of electrical power supplied to various components of cable-preparation device 150. Example components of cable-preparation device 150 include motors and/or actuators driving a tool head or tool-positioning driver, among others. Example characteristics of the electrical power include voltage, current, and/or frequency. In one example, electrical driver 222 outputs a command to a power converter to control the characteristics of the electrical power. In another example, electrical driver 222 includes a power converter to control the characteristics of the electrical power.

FIGS. 3A-3C are perspective views of electrical cable preparation device 150, in accordance with this disclosure. FIG. 3A is a perspective view of electrical cable preparation device 150, FIG. 3B is a transparent perspective view of electrical cable preparation device 150 illustrating internal components relative to housing 154, and FIG. 3C is an internal perspective view of electrical cable preparation device 150.

In the examples shown, electrical cable preparation device 150 includes tool assembly 160 coupled to, supported by, and guided by guide rails 162. Tool assembly 160 includes a rotatable tool head (not visible in FIGS. 3A-3C) comprising a plurality of rollers and at least one cutting tool. Tool assembly 160 also includes a depth driver (not visible FIGS. 3A-3C) configured to insert into the rotatable tool head to adjust a radial depth of the plurality of rollers or a radial depth of the at least one cutting tool,

In the example shown in FIG. 3C, tool assembly 160 includes axial driver 164, tool housing 168, proximal guide 170A and distal guide 170B. Tool housing 168 may include a motor configured to drive any or all of the rollers, the depth driver, or axial driver 164. Tool housing 168 may also include a sensor, such as a camera, control circuitry configured to control the motor, sensor, and/or camera, and a battery configured to provide electrical power to the control circuitry, motor, sensor, and/or camera.

Tool housing 168 may be configured to house the rotatable tool head and provide a mounting structure for the rotatable tool head to couple tool assembly 160 to housing 154 and hold the rotatable tool head in position relative to electrical cable 132. For example, tool housing 168 may be coupled to proximal and distal guides 170A-170B, which are configured to be directly coupled to and movable along guide rails 162, e.g., to be supported and guided by guide rails 162 for axial motion of tool assembly 160 along electrical cable 132.

Tool housing 168 may also be coupled to axial driver 164. Axial driver 164 may be configured to engage with lead screw 166 to move tool assembly 160 axially along guide rails 162. For example, axial driver 164 may include internal threads configured to couple to and/or engage with lead screw 166. Axial driver 164 may also be coupled to a motor, e.g., its own motor, or to a motor within tool housing 168, which may be configured to rotate lead screw 166 so as to cause axial driver 164, and tool assembly 160. to move axially along lead screw 166 and guide rails 162, e.g., via threads of lead screw 166. In other examples, lead screw 166 may be stationary, e.g., fixed at proximal and distal ends of housing 154 so as to not rotate, and axial driver 164 may be configured to cause internal threads engaged with threads of lead screw 166 to rotate to move tool assembly 160 in the proximal or distal axial directions along lead screw 166 and guide rails 162.

Guide rails 162 and lead screw 166 may be directly coupled to (e.g., in contact with and attached to) proximal housing end 158A and distal housing end 158B. Each of proximal and distal housing ends 158A-158B may include a motor, one or more sensors such as a camera, control circuitry configured to control the motor, sensors, and/or camera, and a battery configured to provide electrical power to the motor, sensors, camera, and/or control circuitry. For example, distal housing end 158B may include a camera 174 configured to capture an image of a distal end face of electrical cable 132 and control circuitry to process the image and/or control communication circuitry to send the image to computing device 152 for processing. Proximal housing end 158A may include a camera configured to capture an image of an outer circumferential side of electrical cable 132, e.g., to image the circumferential structure (e.g., of any layers removed) and/or to image or read any labeling on an outer surface of electrical cable 132, and control circuitry to process the image and/or control communication circuitry to send the image to computing device 152 for processing. Proximal housing end 158A may also include a motor configured to cause gripper 156 to grip electrical cable 132. On or both of proximal and distal housing ends 158A-158B may include a motor configured to rotate lead screw 166.

In some examples, housing 154 comprises proximal and distal housing ends 158A-158B, and housing 154 may include a cover or shell at least partially encapsulating proximal and distal housing ends 158A-158B, guide rails 162, lead screw 166, and tool assembly 160. Proximal and distal housing ends 158A-158B may be coupled by guide rails 162 and lead screw 166, and optionally the covering and/or shell, and the axial length L between proximal and distal housing ends 158A-158B may determine the axial working length of tool assembly 160 along electrical cable 132. In some examples, housing 154 may be considered to include all of proximal and distal housing ends 158A-158B, guide rails 162, lead screw 166, and gripper 156.

Gripper 156 is directly coupled to housing 154. In the example shown, gripper 156 is directly coupled to (e.g., in direct contact with and directly attached to) proximal housing end 158A, although in other examples, electrical cable preparation device 150 may comprise more than one gripper 156, e.g., both proximal and distal housing ends 158A-158B may be coupled to a proximal gripper 156 and a distal gripper (not shown). respectively. In some examples, gripper 156 may be integral with housing 154, e.g., housing 154 may include gripper 156. Gripper 156 is configured to directly couple to (e.g., clamp on to) electrical cable 132 and thereby couple housing 154 to electrical cable 132 so as to prevent housing 154 from rotating and/or moving axially relative to electrical cable 132. In the example shown, gripper 156 comprises a nut 176A and collet (not visible) arrangement. For example, nut 176A may be configured to be rotatable to screw into threads of base 176B to move axially towards base 176B and cause a radially inwards compressive force on a tapered collet disposed within nut 176A, and the collet then compresses onto (e.g., clamps onto) electrical cable 132. Nut 176A may also be configured to be rotatable to move axially away from base 176B to reduce the radially inwards compressive force on the collet to release from electrical cable 132.

In some examples, gripper 156, proximal and distal housing ends 158A-158B, and tool assembly 160 (e.g., proximal and distal guides 170A-170B) include cable alignment apertures 172. In some examples, cable alignment apertures 172 may be adjustable and/or replaceable to receive different cable sizes or diameters. For example, cable alignment apertures 172 may be configured to be adjusted by an operator, or replaced by an operator, or computing device 152 may be configured to cause cable alignment apertures 172 to adjust in size or diameter.

In some examples, housing 154 includes one or more openings configured to allow debris, e.g., cutting debris such as cut and removed layer of electrical cable 132, to be removed from electrical cable preparation device 150. For example, housing 154 may comprise proximal and distal housing ends 158A-158B coupled by guide rails 162 and lead screw 156, as shown in FIG. 3C, and housing 154 may not be enclosed by a shell or cover. In some examples, electrical cable preparation device 150 may include a stop to limit the length of electrical cable 132 that may be inserted into electrical cable preparation device 150, e.g., or alternatively to limit the length that electrical cable preparation device 150 may be inserted onto electrical cable 132. In some examples, the stop may be an internal surface of distal housing end 158B.

In some examples, electrical cable preparation device 150 may be configured to enable the rotatable tool head to operate hands-free. For example, electrical cable preparation device 150 may be compact, lightweight, and configured to couple to electrical cable 132 so as to reduce motion, vibration, and torque on electrical cable 132, with minimal or no external support, while the rotatable tool head operates on electrical cable 132. For example, the cross-sectional diameter of electrical cable preparation device 150 (e.g., in a plane substantially perpendicular to its longitudinal axis 180) may be less than 20 inches, or less than 10 inches, or less than 7 inches, or less than 4 inches. In some examples, the maximum cross-sectional dimension of cable preparation device 150 in a direction perpendicular to a longitudinal axis of the electrical cable is less than seven inches

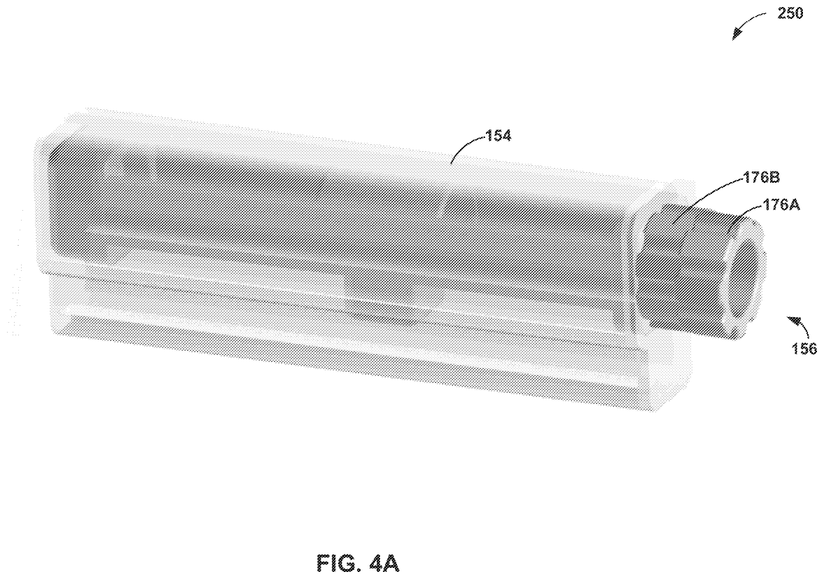

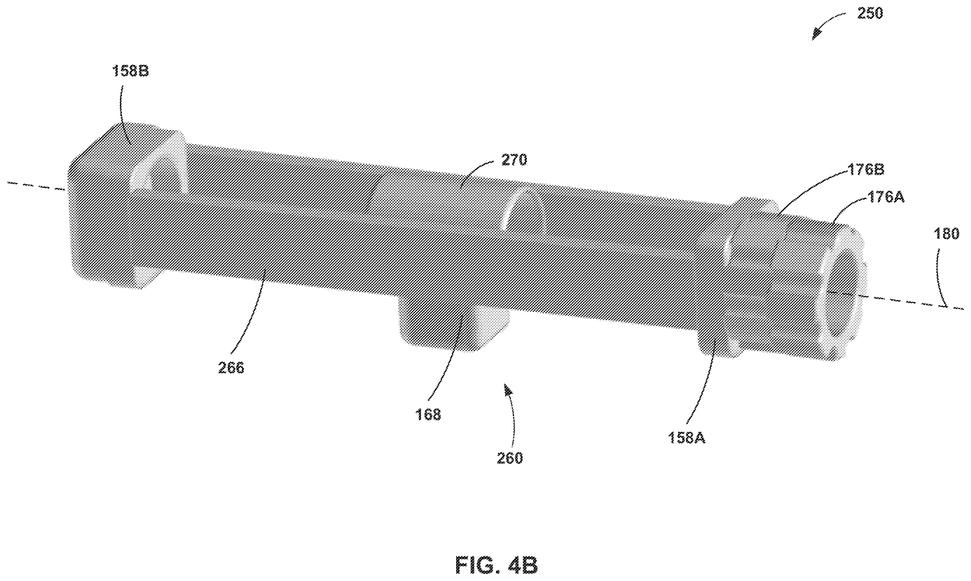

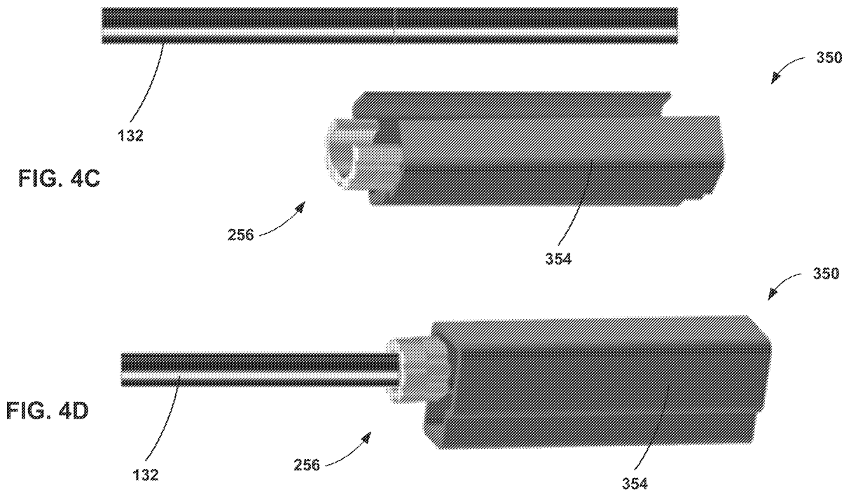

FIGS. 4A-4B are perspective views of electrical cable preparation device 250, in accordance with this disclosure. FIG. 4A is a transparent perspective view of electrical cable preparation device 250 illustrating internal components relative to housing 154, and FIG. 4B is an internal perspective view of electrical cable preparation device 250. Electrical preparation device 250 may be substantially similar to electrical preparation device 150, except that electrical preparation device 250 includes two opposing guide rails 266 and may use a different axial drive mechanism.

For example, electrical cable preparation device 250 may include tool assembly 260, which may be substantially similar to tool assembly 160 described above except that tool assembly 260 includes guide 270. Guide 270 may be configured to house the rotatable tool head and may be coupled to guide rails 266. Electrical cable preparation device 250 may use a lead screw drive mechanism to move tool housing 168 and guide 270, as described above. Alternatively, electrical cable preparation device 250 may include a belt and/or chain drive housed and/or supported by guide rails 260 to move guide 270, tool housing 168, and the rotatable tool head axially. In some examples, electrical cable preparation device 250 may include stepper motors, wheels, ball bearings, or other mechanisms to axially move guide 270, tool housing 168, and the rotatable tool head along guide rails 266.

FIGS. 4C-4D are perspective views of electrical cable preparation device 350 illustrating an alternative mechanism for coupling to electrical cable 132, in accordance with this disclosure. Electrical cable preparation device 350 may be substantially similar to electrical cable preparation devices 150 or 250 described above, except that electrical cable preparation device 350 is configured to open and close in a clamshell configuration. FIG. 4C is a perspective view of electrical cable preparation device 350 in an open configuration, and FIG. 4D is a perspective view of electrical cable preparation device 350 in a closed configuration about electrical cable 132. In the examples shown, gripper 256 is configured to couple to, or clamp on to, electrical cable 132 vis closing on electrical cable 132, and to release from electrical cable 132 via opening. For example, other portions of housing 354 may be configured to open and close to allow electrical cable preparation device 350 to be positioned on (e.g., around, about) electrical cable 132, but not to clamp on to or grip electrical cable 132, and gripper 256 is configured to grip on to electrical cable 132 to couple electrical cable preparation device 350 to electrical cable 132.

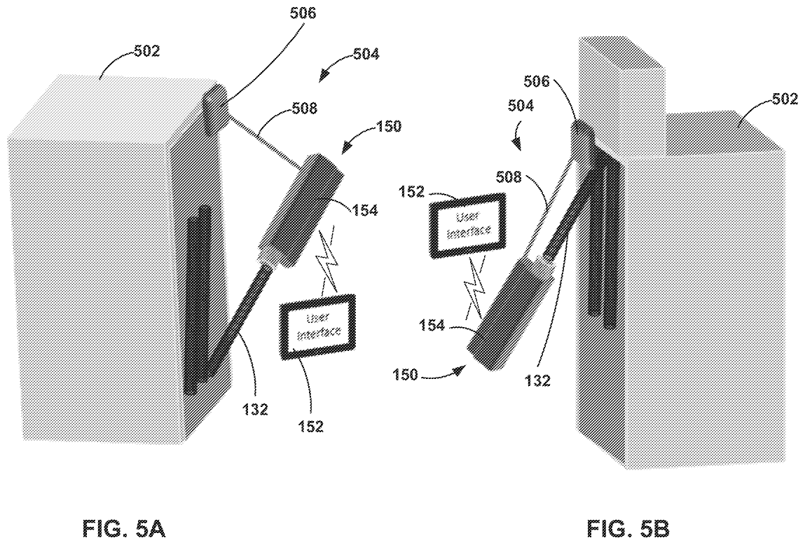

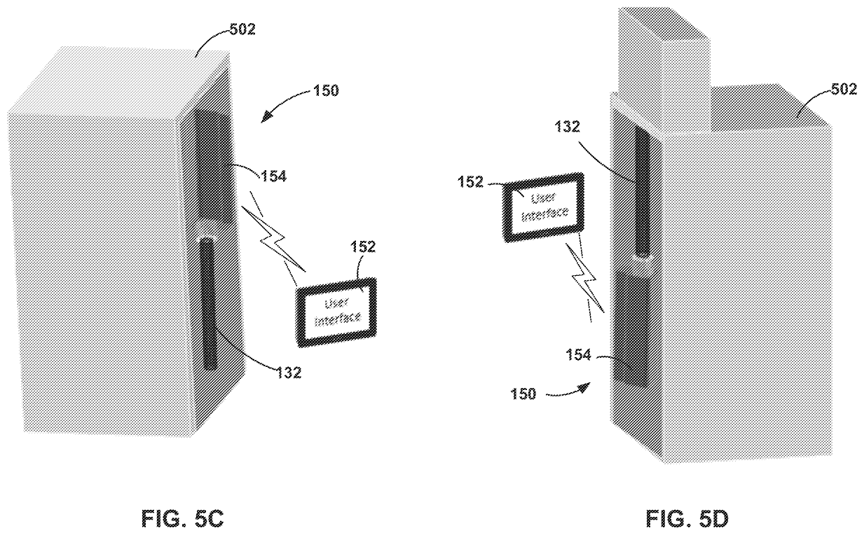

FIGS. 5A and 5B are perspective views of electrical cable preparation device 150 coupled to an electrical cable 132 at an electrical cable cabinet 502, and FIGS. 5C and 5D are perspective views of electrical cable preparation device 150 coupled to an electrical cable 132 within an electrical cable cabinet 502, in accordance with this disclosure.

In the example shown in FIG. 5A, electrical cable preparation device 150 is coupled to electrical cable 132 outside of cabinet 502, where electrical cable 132 is bottom fed into cabinet 502. In the example shown in FIG. 5B, electrical cable preparation device 150 is coupled to electrical cable 132 outside of cabinet 502, where electrical cable 132 is top fed into cabinet 502. In the examples shown, electrical cable 132 is extended from cabinet 502 and electrical cable preparation device 150 may be coupled to electrical cable 132 with minimal bending and/or extension of electrical cable 132 outside of cabinet 502. Electrical cable device 150 may be coupled vertically in either direction, or horizontally (not shown) and stay coupled to electrical cable 132 as the rotatable tool head removes one or more layers of electrical cable 132.

In the examples shown in FIGS. 5A-5B, a mounting support 504 may be attached to electrical cable preparation device 150. In the example shown, a mounting base 506 may be attached to cabinet 502. Mounting based 506 may be configured to attach to cabinet 502 via a magnet, an adhesive, a clamp, or via an suitable attachment mechanism. Mounting support 508 may couple housing 154 of electrical cable preparation device 150 to mounting base 506. In some examples, mounting support 508 may be substantially rigid, e.g., a rod. In other examples, mounting support 508 may be substantially flexible, e.g., a cable. Mounting support 504 is configured to support the weight of electrical cable preparation device 150 to prevent electrical cable preparation device 150 from bending electrical cable 132, and may be configured to reduce a motion of electrical cable preparation device 150 when coupled to electrical cable 132 and during operation of the rotatable tool head, e.g., when the rotatable tool head is rotating about electrical cable 132, moving axially along electrical cable 132, and/or removing a layer of electrical cable 132.

In the examples shown in FIGS. 5C-5D, electrical cable preparation device 150 is coupled to electrical cable within cabinet 502. For example, electrical cable preparation device 150 may be compact, light-weight, and configured to fit within cabinet 502. In some examples, electrical cable preparation device 150 may be configured couple to electrical cable 132, and to operate, within cabinet 502, e.g., without removing a portion electrical cable 132 from cabinet 502. In other examples, electrical cable preparation device 150 may be coupled to electrical cable 132 external to cabinet 502, and then placed within cabinet 502 during operation. In some examples, electrical cable preparation device 150 may be attached to cabinet 502 within cabinet 502, e.g., via mounting support 504 (not shown in FIGS. 5C-5D). In other examples, electrical cable preparation device 150 may be configured to operate while only supported by electrical cable 132.

In some examples, electrical cable preparation device 150 may be configured to communicate with, and to be controlled by, computing device 152. In the example shown, computing device 152 may cause electrical cable preparation device 150 to grip electrical cable 132 and removed a layer of electrical cable 132 without physical assistance or support of an operator (e.g., other than to mount electrical cable preparation device 150 over electrical cable 132). In some examples, any of electrical cable preparation device 150, 250, or 350 may be used in the examples illustrated in FIGS. 5A-5D.

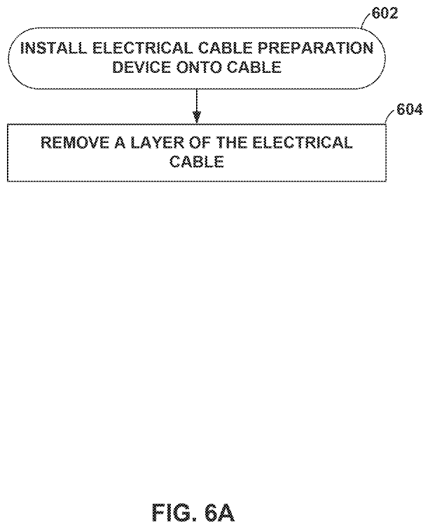

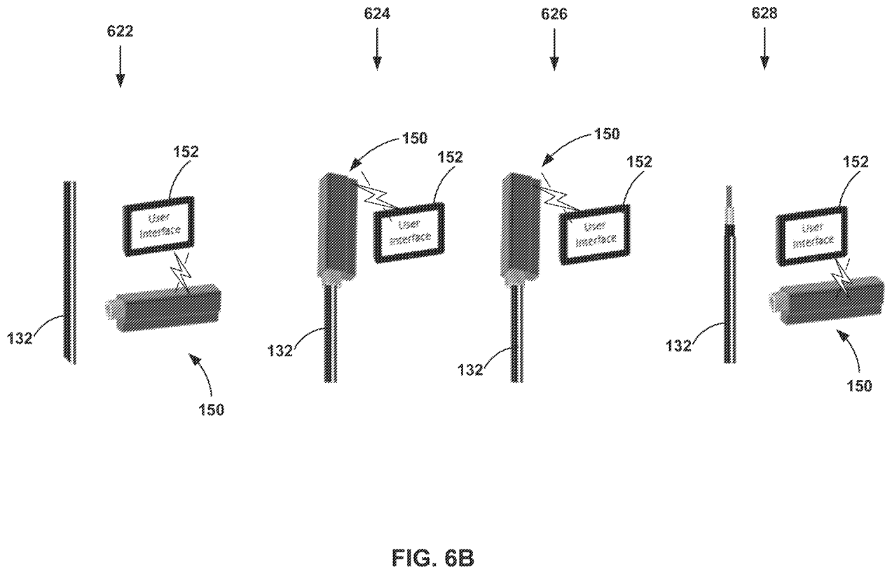

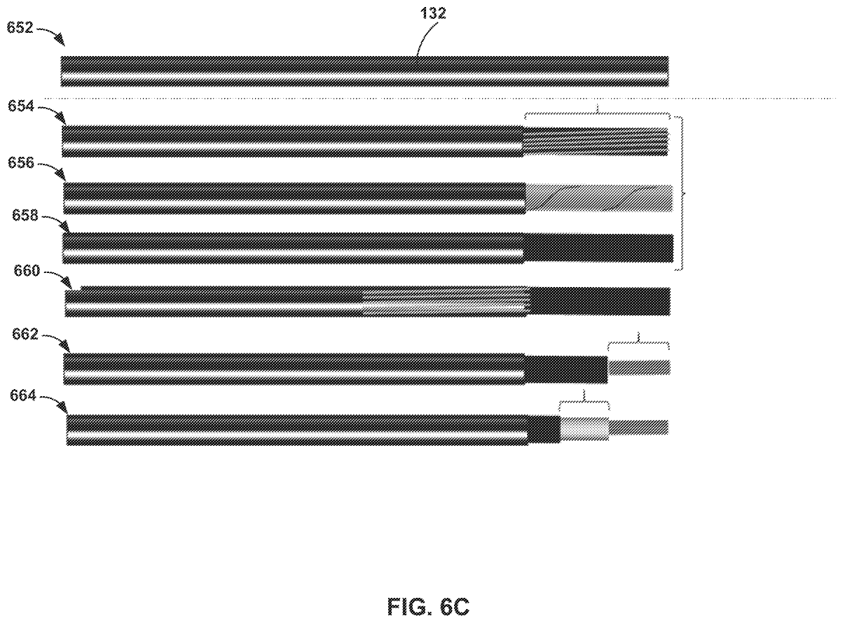

FIGS. 6A-6C illustrate an example technique of preparing an electrical cable using electrical cable preparation device 150, 250, or 350. FIG. 6A is a flow chart of an example method of preparing electrical cable 132 using cable preparation device 150, FIG. 6B a conceptual diagram illustrating details of the example technique of FIG. 6A, and FIG. 6C a conceptual diagram illustrating electrical cable 132 at different stages of preparation. Although the method of FIG. 6A is described with reference to FIG. 6B, electrical power system 100A, cable preparation system 100B, and electrical preparation device 150, other systems and devices may be used, e.g., electrical cable preparation devices 250 or 350.

An operator may install electrical cable preparation device 150 onto electrical cable 132 (602). For example, an operator may open electrical box 502 and slide cable preparation device 150 over electrical cable 132, e.g., through apertures 172. In some examples, the operator may slide cable preparation device 150 over electrical cable 132 for a length L, or in other examples until a distal end of electrical cable 132 comes into contact with a mechanical stop of cable preparation device 150, e.g., an internal surface of distal housing end 158B. Alternatively, the operator may install electrical cable preparation device 350 by opening electrical cable preparation device 350, positioning electrical cable preparation device 350 over electrical cable 132, and closing electrical cable preparation device 350.

In some examples, just prior to (e.g., at stage 622 of FIG. 6B), or just after, installing electrical cable preparation device 150 onto electrical cable 132, the operator may select and/or enter parameters for removing at least one layer of electrical cable 132. For example, the operator may select and/or input cut back parameters or other information (e.g., location identification, device identification, date and time, or the like) into computing device 152, which may then communicate the parameters to electrical cable preparation device 150.

In some examples, once electrical cable preparation device 150 is positioned onto electrical cable 132, the operator may cause gripper 156 to grip electrical cable 132, as shown at stage 624 of FIG. 6B. For example, the operator twist or screw on nut 176A to tighten gripper 156, or the operator may close electrical cable preparation device 350, thereby closing and clamping gripper 356 onto electrical cable 132. Alternatively, the operator may indicate that electrical cable preparation device 150 is ready for gripping by inputting information or making a selection via computing device 152. Computing device 152 may then communicate with electrical cable preparation device 150, and control circuitry may cause gripper 156 to tighten and grip electrical cable 132, e.g., in response to a command from computing device 152. Alternatively, the operator may close electrical cable preparation device 350 without gripper 356 gripping electrical cable 132, the operator may then make fine adjustments to the axial position of electrical cable preparation device 350 along electrical cable 132, the operator may then select an option via computing device 152 and control circuitry may cause gripper 356 to grip electrical cable 132.

Electrical cable preparation device 150 may remove one or more layers of electrical cable 132 (604). For example, electrical cable preparation device 150 may measure one or more dimensions of electrical cable 132 via a sensor or camera and complete the required steps to remove a layer of electrical cable 132. In some examples, an operator may receive information regarding the required steps, via computing device 152, and may input information, make selections, and/or approve steps to remove a layer of electrical cable 132, e.g., at stage 626 shown in FIG. 6B. Electrical cable preparation device 150 may inspect electrical cable 132 via sensors or cameras at each of the required steps.

In some examples, electrical cable preparation device 150 may position a rotatable tool head at an end of electrical cable 132. For example, control circuitry may cause electrical cable preparation device 150 to position the rotatable tool head at an end of electrical cable 132. Control circuitry may then cause electrical cable preparation device 150 to adjust a radial depth of at least one cutting tool of the rotatable tool head to a preprogrammed cutting depth. For example, control circuitry may cause electrical cable preparation device 150 to insert a depth driver into the rotatable tool head to engage a radial depth adjusting mechanism of the rotatable tool head and to rotate the depth driver to adjust the radial depth of the at least one cutting tool.

The control circuitry may cause electrical cable preparation device 150 to insert the at least one cutting tool of the rotatable tool head into at least one layer of electrical cable 132 to a predetermined depth and to rotate the at least one cutting tool to a predetermined pitch. The control circuitry may then cause electrical cable preparation device 150 to rotate the rotatable tool head to create a spiral cut through at least one layer of electrical cable 132.

For example, the control circuitry may cause axial driver 164 to move the rotatable tool head longitudinally along guide rail 162 while electrical cable preparation device 150 rotates the rotatable tool head about electrical cable 132 with the at least one cutting tool at the predetermined depth, e.g., to make the spiral cut. While electrical cable preparation device 150 rotates the rotatable head about electrical cable 132 and axial driver 164 moves the rotatable head axially along electrical cable 132, gripper 156 holds housing 154 and guide rails 162 to be stationary relative to electrical cable 132.

The operator may then remove electrical cable preparation device 150 from electrical cable 132. For example, the operator may loosen gripper 156, or open electrical cable preparation device 350. In some examples, the operator may interact with computing device 152 such that control circuitry causes electrical cable preparation device 150 to loosen gripper 156 (or gripper 356). The operator may then slide electrical cable preparation device 150 off of electrical cable 132, e.g., as shown at stage 628 of FIG. 6B.

FIG. 6C is a conceptual diagram illustrating an example of a method of preparing an end of an electrical power cable 132 using electrical cable preparation device 150, in accordance with various techniques of this disclosure. In step 652, electrical cable preparation device 150 (not shown in FIG. 6C) is coupled to electrical cable 132. In optional step, a terminal end (e.g., a distal end) of electrical cable 132 is cut substantially perpendicular to an axis of electrical cable 132. In step 654, a jacket of electrical cable 132 is removed. In steps 656 and 658, a shield (e.g., wire, foil, or other shield material) of electrical cable 132 is removed and is optionally folded back (as shown at step 660) over the uncut jacket. In step 660, the insulation screen and insulation of electrical cable 132 is removed to expose the central conductor. In step 662, a second portion of the insulation screen is removed to expose a portion of the insulation. In some examples, a terminal portion of the cable jacket may be left on the cable to provide an uncut portion of the cable jacket to which to couple electrical preparation device 150 prior to cutting one or more layers of electrical cable 132.

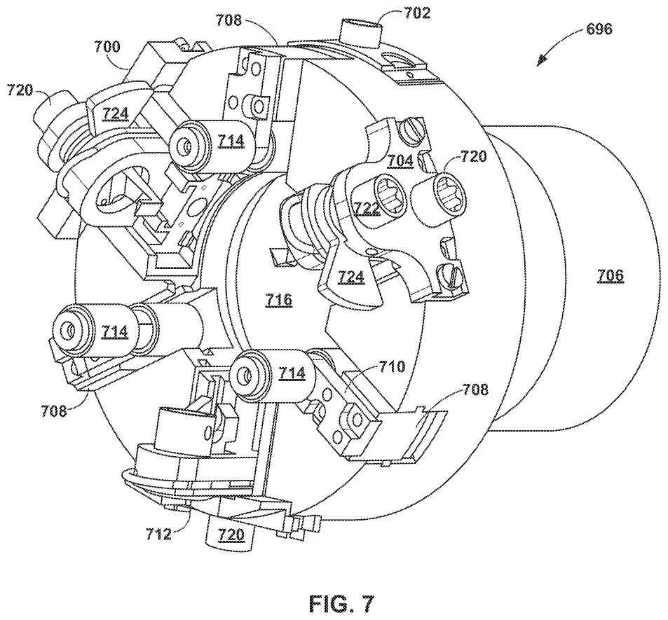

FIG. 7 is a perspective view of an example of rotating tool head 696 (alternatively referred to as rotating tool assembly 696) of electrical cable preparation device 150 (or 250 or 350), in accordance with this disclosure. As shown in the example of FIG. 7, rotating head assembly 696 includes an insulation-blade-assembly holder 700, a rollers key 702, a jacket-blade-assembly holder 704, a head body 706, roller-bearing assemblies 708 (also referred to herein as “roller chucks 708”), roller holders 710, an insulation-screen-blade holder 712, rollers 714, and a cable channel 716.

In the example of FIG. 7, rotating head assembly 696 includes three roller-bearing assemblies 708, as well as three blade assemblies 700, 704, and 712. Each of blade assemblies 700, 704, and 712 includes a corresponding radial-depth-adjustment mechanism 720 which, when turned in a clockwise or counterclockwise direction, raises or lowers the respective blade assembly toward or away from cable channel 716. At least one blade assembly (e.g., as shown in FIG. 7 with respect to jacket-blade-assembly holder 704) includes a pitch-adjustment mechanism 722, which can control the pitch of the respective blade. Further, all blade assemblies 700, 704, and 712 include a corresponding reflection target 724 to enable distance measurement for closed-loop positional adjustment. Such distance measurements may include light-based measurements, such as laser measurements, as one non-limiting example.

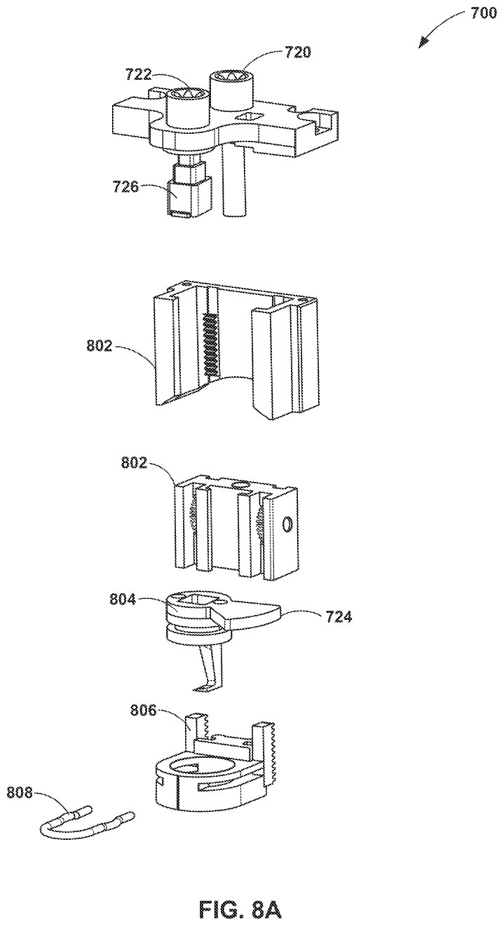

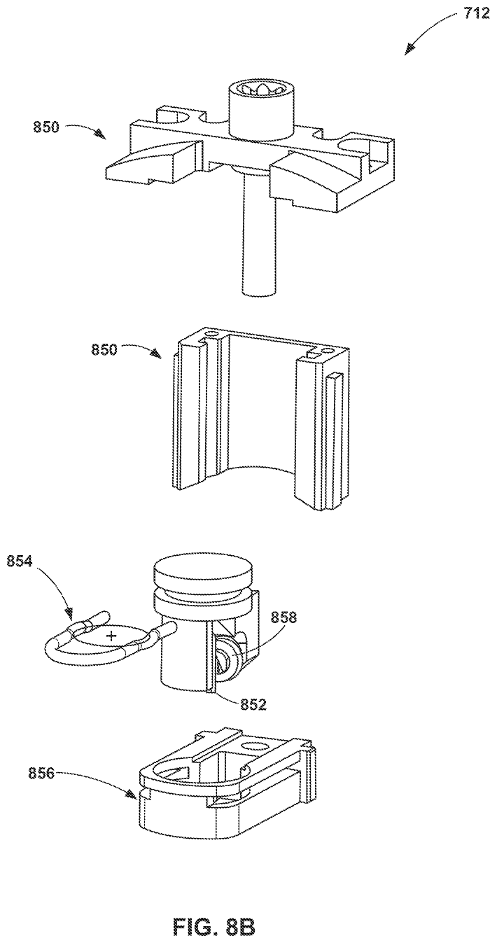

FIG. 8A is an exploded view of an example of insulation-blade-assembly holder 700 of FIG. 7, in accordance with this disclosure. Insulation-blade-assembly holder 700 includes pitch-adjustment mechanism 722, a blade-holder mechanism 802, a blade 804 (which may be an example of an insulation blade or a jacket blade), a blade house 806, and a mounting spring 808. In some examples, assembly 700 includes a telescoping mechanism 720 in order to extend the radial range-of-motion of blade 804. Telescoping mechanism 720 can move blade 804 in a direction upward or downward along blade-holder mechanism 802. Pitch-adjustment mechanism 722 can rotate blade 804 and change the pitch with which blade 804 contacts cable 132 (FIG. 1B).

Telescoping mechanism 720 is configured to, when rotated, control the radial depth of blade 804. In some examples, a jacket blade may not need to be telescopic, while an insulation blade may need to be telescopic, such as when the insulation blade needs to move radially inward from an “open” position toward a radial position located at the exterior surface of a small conductor cable 132). Pitch-adjustment mechanism 722 is configured to, when rotated, control the pitch of blade 804. During operation, blade 804 first contacts jacket 262 or insulation 256 (FIG. 2) and begins to peel jacket 262 off of cable 132. Blade 804 may be extended to the correct radial depth, peeling jacket 262 from the cut end of cable 132.

FIG. 8B is an exploded view of an example of insulation-screen-blade holder 712 of FIG. 7, in accordance with this disclosure. In the example of FIG. 8B, insulation-screen-blade holder 712 includes a blade-holder mechanism 850, an insulation-screen knife 852 having a mounting-height limiter 858, a mounting spring 854, and a blade house 856. Insulation-screen knife 852 extends past mounting-height limiter 858 to a pre-determined distance. Mounting-height limiter 858 rides on the surface of insulation screen 258 during the scoring operation. The score has a predetermined radial depth (as measured from the outer surface of cable 132). In one example, insulation-screen-blade holder 712 may include a domed support rather than a roller, as shown in FIG. 8B. Blade 804 (FIG. 8A) can extend from the tip of the dome, and the dome then rides on conductor screen 254 (FIG. 2). In some examples, blade-holder mechanism 850 may include one or more set screws or other mechanical fasteners, rather than a mounting spring 854, in order to retain a blade (e.g., insulation-screen blade 852) within blade-holder mechanism 850.

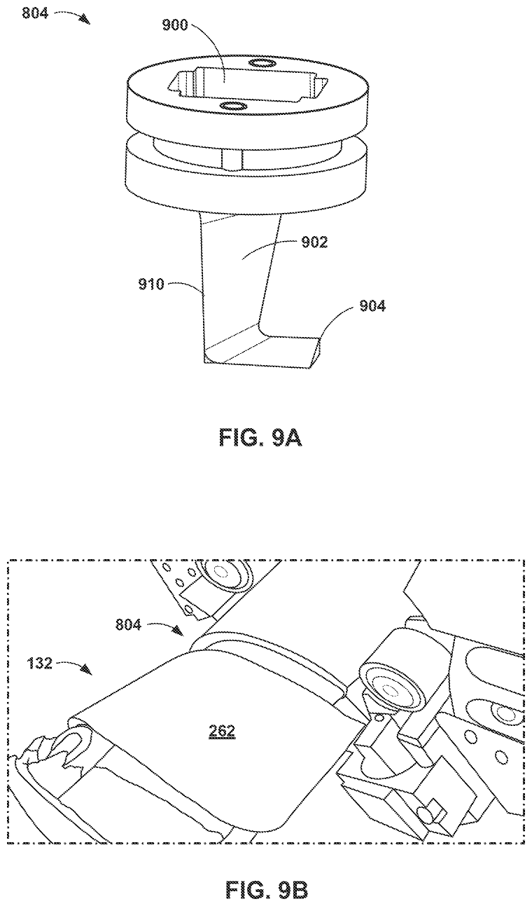

FIG. 9A depicts an example of blade 804 of FIG. 8A, in accordance with this disclosure. Blade 804 can be utilized with either of insulation-blade-assembly holder 700 and/or jacket-blade-assembly holder 704 of FIG. 7. Blade 804 includes an interface 900 that is configured to couple with bit 726 (FIG. 8A), located at a distal end of pitch-adjustment mechanism 722. A cutting blade 902 is located just underneath interface 900 along with a positioning-and-lifting blade 904. As shown in FIG. 9B, blade 804 can remove jacket 262 (and/or insulation 256) from cable 132 by cutting jacket 262 (and/or insulation 256) with cutting blade 902 and then lifting jacket 262 (and/or insulation 256) from cable 132 with positioning-and-lifting blade 904. Pitch-adjustment mechanism 722 is configured to rotate to change the pitch of blade 804, and in particular, cutting blade 902. Blade 804 may be formed from virtually any suitable material such as metal, a hard plastic, wood, etc.

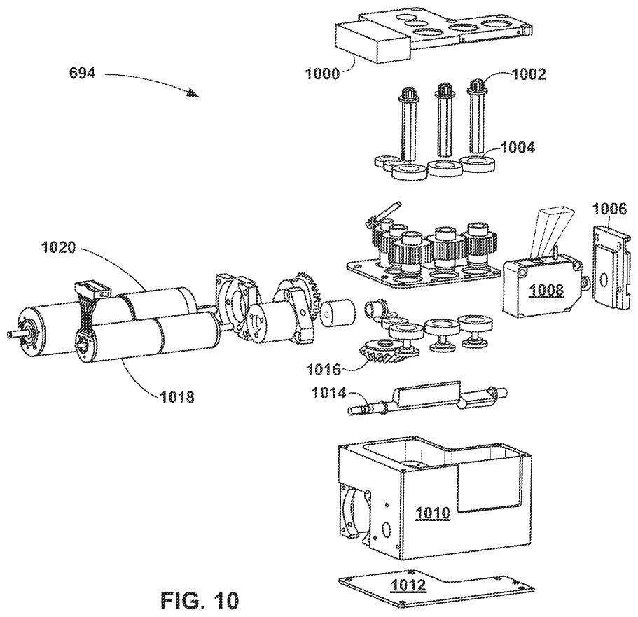

FIG. 10 is an exploded view of an example of screwdriver assembly 694, in accordance with this disclosure. In some examples, screwdriver assembly 694 may be responsible for the movement of all of rollers 714 (FIG. 7), the insulation and jacket blades (e.g., blade 804 of FIG. 8A), and insulation-screen knife 852 (FIG. 8B), through engagement of telescoping mechanism 720 and pitch-adjustment mechanism 722.

Screwdriver assembly 694 is configured to have a top seal plate 1000, screwdrivers 1002, bearings 1004, a cam shaft plate 1006, a laser distance sensor 1008 (e.g., utilizing a laser triangulation method), a motor-and-gear box 1010, a bottom seal plate 1012, a cam shaft 1014, a bevel gear 1016, a cam shaft motor 1018, and a screwdriver motor 1020. In operation, cam shaft engine 1018 engages and moves one or more selected screwdrivers 1002 in an upward direction to engage one or more of rollers key 702, telescoping mechanism 720, and/or pitch-adjustment mechanism 722. When screwdrivers 1002 are engaged within rollers key 702, telescoping mechanism 720, and/or pitch-adjustment mechanism 722, screwdriver engine 1020 engages and turns screwdrivers 1002 to rotate rollers key 702, telescoping mechanism 720, and/or pitch-adjustment mechanism 722 in a clockwise or counterclockwise direction.

In some examples, screwdriver motor 1020 may include a maxon® EC-i series motor, available from maxon precision motors of Taunton, Massachusetts, e.g., having about a 30 mm diameter, a rated power of about 75 W, and having a rated torque of about 0.11 N-m. Screwdriver motor 1020 can be provided in combination with a gear ratio of about 103:1, which can deliver about 6 N-m of torque. However, any suitable type of motor could be utilized according to examples of this disclosure.

In some examples, cam shaft motor 1018 may include a maxon® ECX series motor, available from maxon precision motors of Taunton, Massachusetts, e.g., having about a 19 mm diameter, a rated power of about 34 W, and a rated torque of about 7 mN-m. Cam shaft motor 1018 may be provided in combination with a gear ratio of about 111:1, which can deliver about 0.5 N-m of torque. However, any suitable type of motor could be utilized according to examples of this disclosure.

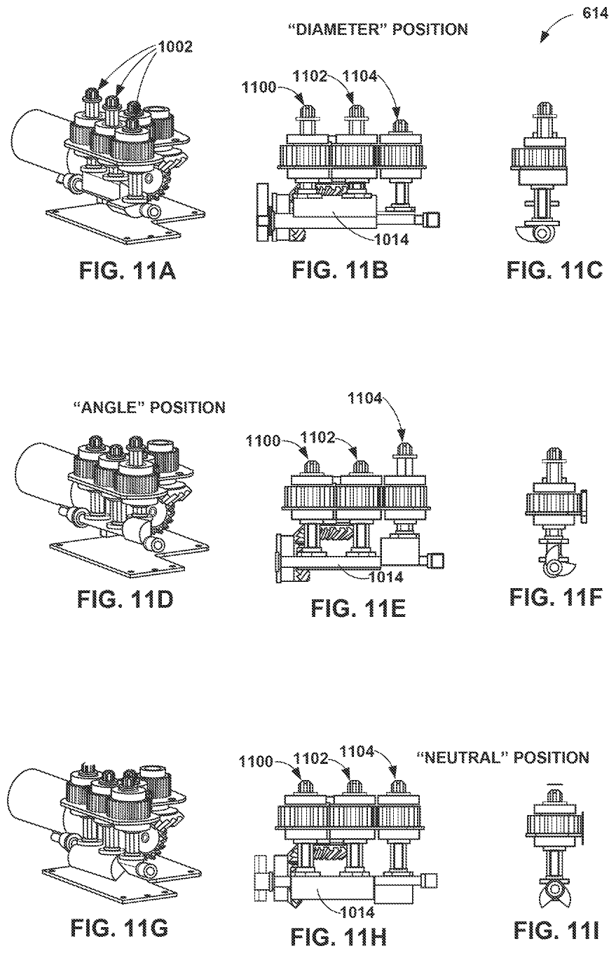

FIGS. 11A-11I are diagrams of an example of screwdrivers assembly 694 of FIG. 10, including screwdrivers 1002 and camshaft 1014, in accordance with this disclosure. In the examples of FIGS. 11A-11I, screwdrivers 1002 collectively include three individual screwdrivers 1100, 1102, and 1104.

In FIGS. 11A, 11B, and 11C, screwdrivers 1100, 1102, and 1104 are set at a “diameter” position, meaning that two of the aft screwdrivers (e.g., screwdrivers 1100 and 1102) are in an “engaged” position and extended to engage rollers key 702 and telescoping mechanism 720 (FIG. 7). Cam shaft 1014 is shown in a “rotated” position in which cam shaft 1014 is pushing upward on screwdrivers 1100 and 1102 (as shown in FIGS. 11B), causing them to engage rollers key 702 and telescoping mechanism 720. Control circuitry may cause roller chucks 708 to move toward cable 132 (FIG. 1B) located within electrical cable preparation device 150 by causing screwdriver engine 1020 to engage and rotate screwdriver 1100 in a clockwise or counterclockwise direction as desired.

Further, control circuitry may cause insulation blade 804 to lower to contact cable 132 within MWM 350, by causing screwdriver engine 1020 to engage screwdriver 1102 to rotate, thereby causing telescoping mechanism 720 to rotate in a clockwise or counterclockwise direction.

FIG. 11D, 11E and 11F show screwdrivers 1002 in an “angle” position, meaning that screwdrivers 1100 and 1102 are in a “neutral” position and screwdriver 1104 is in an “engaged” position. Cam shaft 1014 has rotated and elevated screwdriver 1104. Screwdriver 1104 can engage pitch-adjustment mechanism 722 and can be rotated in a clockwise or counterclockwise direction by screwdriver engine 1020. In FIGS. 11G, 11H and III, all three screwdrivers 1100, 1102, and 1104 are in “neutral” positions, meaning that cam shaft 1014 is rotated to a position in which none of screwdrivers 1100, 1102, or 1104 is extending upward.

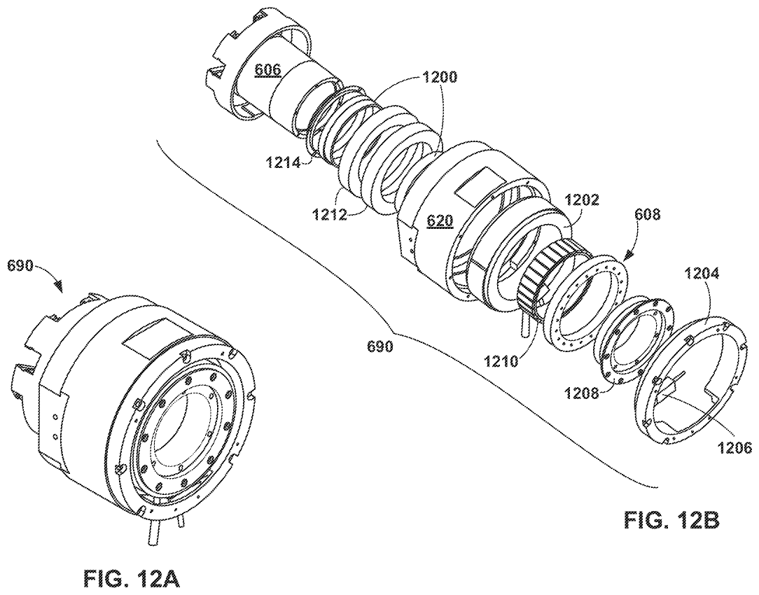

FIGS. 12A and 12B show a profile view and an exploded view, respectively, of an example of motor 690 (alternatively, “direct-drive mechanism 690” or “direct drive 690”), in accordance with this disclosure. Direct drive 690 is shown with rotating head assembly 696, spacers 1200, stator 1202, encoder ring 608, stator lock plate 1204, encoder reader 1206, rotor lock plate 1208, rotor 1210, chassis 620, bearings 1212 and bushing 1214.

Rotor 1210 is a cylindrical-shaped rotor and can be made of solid steel. In some examples, rotor 1210 includes a brushless DC (“BLDC”) motor topology and contains permanent magnets. Rotor 1210, encoder ring 608, and other components are connected to the rotating head 696 and secured to frame 620 by bearings. Encoder ring 608 and encoder ring 1206 make up an electromechanical device configured to measure the angular position or motion of rotor 1210, and may output the measurements in the form of analog or digital output signals. Encoder ring 608 could be an absolute decoder or an incremental encoder.

In some examples, motor 690 is essentially a spinning electromotive device. Stator 1202 may act as a field magnet, interacting with the rotor 1210 to create circular motion. The circular motion essentially rotates the head body 696 around a cable 132. In some examples, motor 690 could be a Model QTR-A-133-34 linear motor, available from Tecnotion of Almelo, Netherlands, or virtually any type of motor providing rotational motion.

In some examples, motor 690 may alternatively be a bi-directional gear and main-motor assembly, and motor 690 may be configured to drive a bi-directional gear assembly (not shown). The bi-directional gear assembly may provide a gear system with a 1:1 ratio in one direction, and a 1:X ratio in the reverse direction, where X is a number within a range from about 0.1 to about 10. For example, the gear assembly may include a sprag gear that, when operated in a first direction, disengages, thereby transferring a rotation in a 1:1 ratio to an output shaft, and, when operated in a second direction opposite the first direction, engages a planetary gear assembly which drives the output shaft at a different gear ratio of 1:X, where X is a number within a range from about 0.1 to about 10.

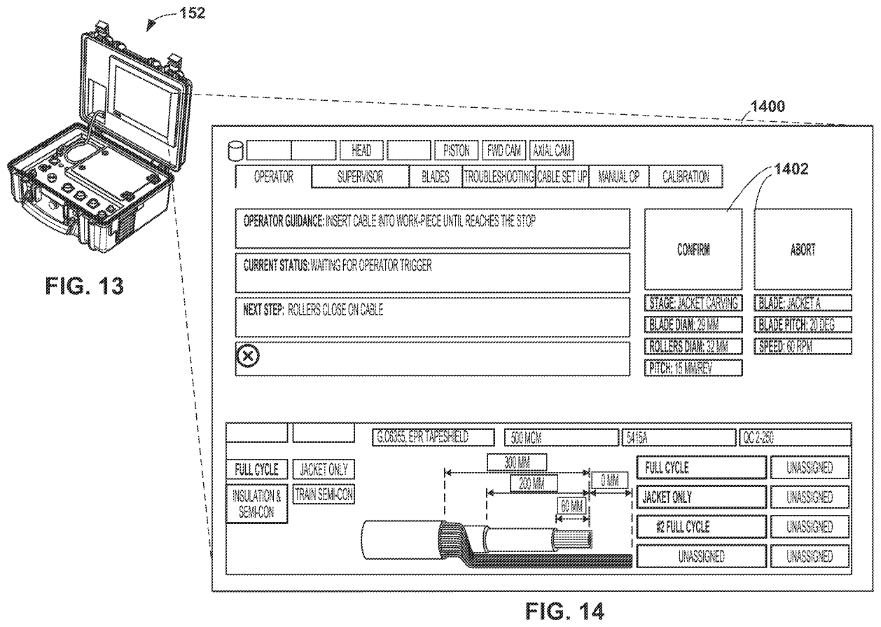

FIG. 13 is an illustrative diagram of an example of computing device 152 of FIG. 1B, and FIG. 14 is an illustrative diagram of an example graphical user interface (GUI) 1400 that computing device 152 may generate and display on a screen of computing device 152, in accordance with this disclosure. As shown in FIG. 14, GUI 1400 includes a plurality of virtual input-output mechanisms 1402 (e.g., buttons, input boxes, sliders, text boxes, etc.) configured to enable an operator or other user to control electrical cable preparation device 150 via computing device 152, to prepare electrical cable 132 (FIG. 1B) for connection to an electrical power system 100A (FIG. 1A).

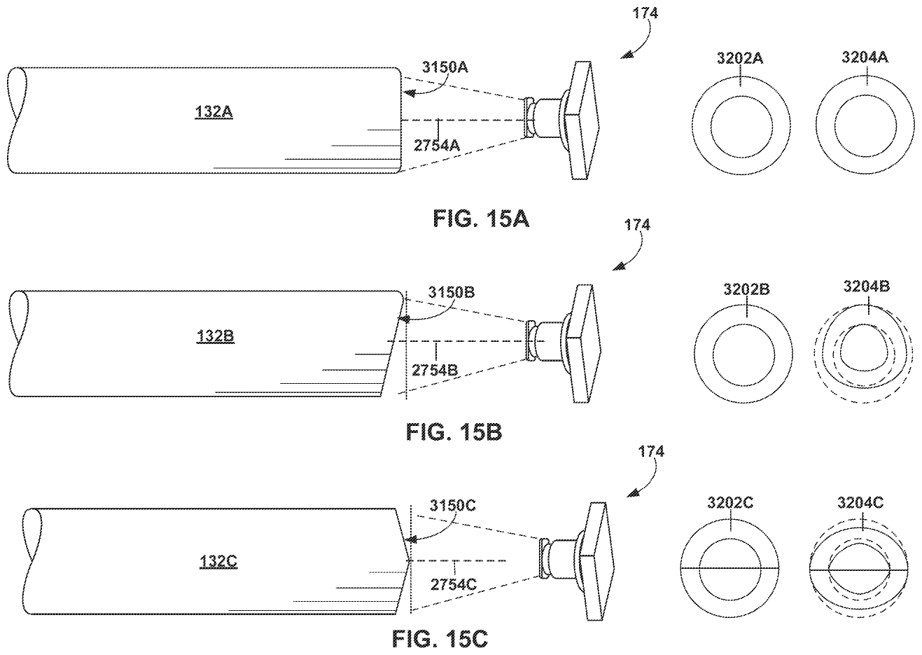

FIGS. 15A-15C are conceptual diagrams illustrating example functionality of a camera 174 (FIG. 3C) of electrical cable preparation device 150. For example, FIG. 15A depicts a first example electrical cable 132A having a theoretical “ideal” end-face 3150A. wherein end-face 3150A (at least substantially) conforms to a single planar surface, and wherein the planar surface of end face 3150A is (at least substantially) perpendicular to a central longitudinal axis 2754A of cable 132A. In such examples, a camera 174 that includes a telecentric lens is substantially likely to capture an image 3202A that is visually similar to an image 3204A that is captured by a cross-section sensing module that does not include a telecentric lens. In other words, the two images 3202A and 3204A will be substantially similar, due primarily to the “ideal” surface of end-face 3150A.

However, FIG. 15B depicts a second example electrical cable 132B having a non-ideal end-face 3150B, wherein end-face 3150B (at least substantially) conforms to a single planar surface, but wherein the planar surface is not substantially perpendicular to a central longitudinal axis 2754B of cable 132B. For example, as shown in FIG. 15B, cable end face 3150B is oriented at an oblique angle with respect to central longitudinal axis 2754B. In such examples, camera 174 may include a telecentric lens that is configured to capture an image 3202B that is substantially different from an image 3204B that is captured by a camera that does not include a telecentric lens (e.g., that includes only conventional optical lenses). For example, as shown in FIG. 15B, a lower portion of end-face 3150B appears distorted in image 3204B, in that the lower portion that is slightly farther away from the camera 3110 of the camera is shrunken or reduced by an amount based on its distance from camera 3110. Accordingly, image 3204B would otherwise result in inaccurate measurements of the layers of cable 132B, e.g., measurements of the diameters, radii, radial thicknesses, are-lengths, or other similar dimensions. These inaccurate measurements may result in inaccurate cutting or shaving of the one or more layers, as the respective cable-preparation system may determine a radial depth of its cutting tool at least in part on the inaccurate measurements. However, by incorporating telecentric lens into camera 174, each portion of end-face 3150B is magnified by the same amount, regardless of its distance from lens, resulting in image 3202B having the appearance that end-face 3150B is substantially “ideal,” e.g., substantially planar and substantially perpendicular to cable axis 2754B.

Similarly, FIG. 15C depicts a third example electrical cable 132C having a non-ideal end-face 3150C, wherein end-face 3150C doesn't conform to a single planar surface, and where none of the multiple planar surfaces are oriented substantially perpendicularly to central longitudinal axis 2754C of cable 132C, e.g., are oriented at oblique angles with respect to central longitudinal axis 2654C. In such examples, a camera 174 that includes a telecentric lens is configured to capture an image 3202C that substantially different from an image 3204C that is captured by a camera that does not include a telecentric lens. For example, as shown in FIG. 15C, both an upper portion and a lower portion of end-face 3150C appear distorted in image 3204C, in that the upper and lower edges are slightly farther away from the camera 3110 of camera 174 than a middle portion, and accordingly. but the upper and lower portions are shrunken or reduced by an amount based on their respective distance from camera 3110. Accordingly, image 3204C would otherwise result in inaccurate measurements of the layers of cable 132C, e.g., measurements of the diameters, radii, radial thicknesses, arc-lengths, or other similar dimensions. These inaccurate measurements would similarly result in inaccurate cutting or shaving of the one or more layers, as the cable-preparation system would be basing a radial depth of the cutting tool at least in part on the measurements. However, by incorporating telecentric lens into camera 174, the magnification of each portion of end-face 3150C is magnified by the same amount, regardless of its distance from camera 3110, resulting in image 3202C having the appearance that end-face 3150C is substantially ideal.

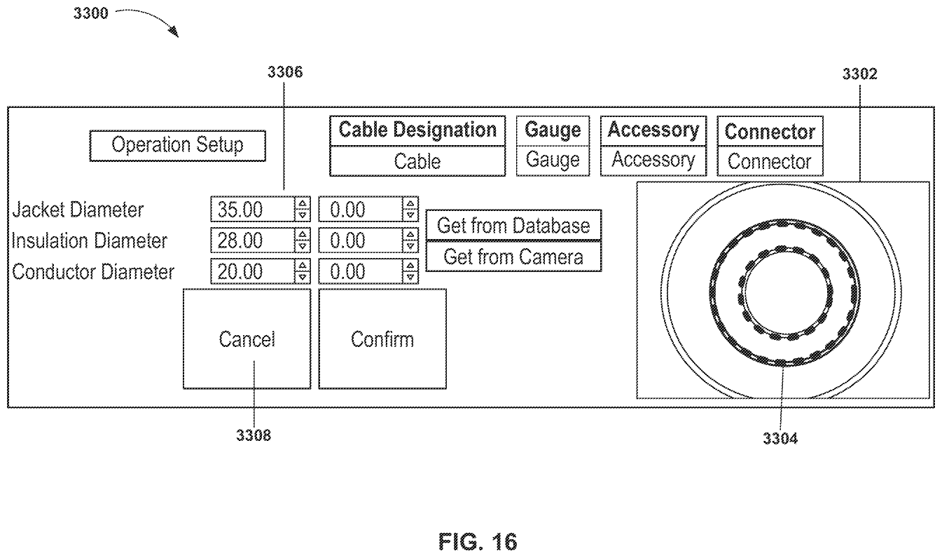

FIG. 16 is an illustrative diagram depicting an example graphical user interface (GUI) 3300 that may be generated by, or in conjunction with, electrical preparation device 150. In the example shown in FIG. 16, GUI 3300 includes an image 3302 of the end-face 3150 of the cable 132, as captured by camera 174. In some examples, a computing device (e.g., computing device 152, or any other computing device of system 100B of FIG. 1B) is configured to process image 3302 to identify or determine, based on image 3302, an approximate location of, or demarcation (e.g., distinction) between, the various layers of electrical cable 132 within image 3302, Accordingly, as shown in FIG. 16, image 3302 may include one or more geometric objects (e.g., rings, etc.) 3304 overlaying image 3302 and indicating the estimated demarcations between the layers of cable 132.

GUI 3300 may further include estimations of various measurements and dimensions corresponding to the estimated locations of or demarcations between the various layers of the cable. In some examples, GUI 3300 further includes input devices 3306 enabling a user to either confirm or reject (“Cancel”) the estimated measurements, as appropriate. Upon receiving a “Cancel” indication from the user, the system may automatically re-capture another image 3302 of the end-face 3150 of cable 132, and re-generate the measurements based on the new image. Upon receiving a “confirm” indication from the user, the system may transmit the measured dimensions to another computing device (e.g., from computing device 152 to control circuitry of electrical cable preparation device 150). Additionally or alternatively, in response to receiving a “confirm” indication from the user via GUI 3300, the respective computing system may be configured to automatically generate and execute corresponding program instructions to configure electrical cable preparation device 150 for preparing electrical cable 132 (e.g., adjusting an orientation and/or radial depth of one or more cutting blades), and/or to cause electrical cable preparation device 150 to begin cutting the one or more layers of cable 132.

In some examples in accordance with this disclosure, a computing system may be configured to determine and output, such as via GUI 3300, additional or differing indications to a user. For example, the computing systems of this disclosure (e.g., computing device 152) may be configured to determine, based on the measured dimensions within image 3302 of cable 132, whether the measured dimensions correspond to a type of electrical cable indicated by the user (e.g., via GUI 3300 or other user-input mechanism). For example, the computing system may be configured to determine whether the imaged electrical cable 132 includes an expected number of layers, expected types of layers, expected thicknesses of layers (e.g., within a threshold tolerance) conductor size and stranding, insulation thickness and voltage class, type of shielding, an overall cable diameter, or the like. In the event that the computing system determines that a cable parameter of this type is outside an expected value or range, the computing system may generate and output an alert, such as via GUI 3300, to inform the user that the cable is different from the type of cable previously indicated or described by the user, such that the user may determine whether the discrepancy was based on user error, or if camera 174 may need to be re-calibrated.

In some examples in accordance with this disclosure, a computing system may be configured to determine, based on the measured dimensions within image 3302 of cable 132, that cable 132 is excessively deformed or otherwise out-of-specification, such that attempting to prepare the cable is not likely to be completed successfully, or alternatively, that the preparation procedure may be completed but may produce a prepared cable that is unsafe to use. For example, the computing system may be configured to determine (e.g., measure) an eccentricity (e.g., an “ovality”) of the cross-section of cable 132, or an excessive or insufficient layer thickness, or any other similar parameter that is not within a safe or expected tolerance for the cable-preparation system. In some such examples, the computing system may generate and output an alert, such as via GUI 3300, that the cable should not be used with the cable-preparation system, and should likely be discarded.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with.” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although several distinct modules have been described throughout this description, many of which perform unique functions, all the functions of all the modules may be combined into a single module, or even split into further additional modules. The modules described herein are only exemplary and have been described as such for better case of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some respects, the functionality described herein may be provided within dedicated software modules or hardware modules configured for performing the techniques of this disclosure, Even if implemented in software, the techniques may use hardware such as a processor to execute the software, and a memory to store the software. In any such cases, the computers described herein may define a specific machine that can execute the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium, It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAS), or other equivalent integrated or discrete logic circuitry. Accordingly, the term “processor”, as used may refer to any of the foregoing structure or any other structure suitable for implementation of the techniques described. In addition, in some respects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

1: An electrical cable preparation device comprising:
a rotatable tool head comprising:
a plurality of rollers; and
at least one cutting tool;
a depth driver configured to insert into the rotatable tool head to adjust a radial depth of the plurality of rollers or a radial depth of the at least one cutting tool;
a housing configured to house the rotatable tool head and to allow the rotatable tool head to rotate about an electrical cable and move axially along the electrical cable; and
a gripper configured to couple the housing to the electrical cable, wherein the gripper is configured to prevent the housing from rotating or moving axially relative to the electrical cable,
wherein the electrical cable preparation device is configured to remove one or more layers of the electrical cable.

2: The electrical cable preparation device of claim 1, wherein the gripper comprises a nut and a collet.

3: The electrical cable preparation device of claim 1, wherein the gripper comprises a clamshell clamp.

4: The electrical cable preparation device of claim 1, wherein the housing comprises a guide rail extending parallel to a longitudinal axis of the electrical cable and configured to guide axial movement of the rotatable tool head along the electrical cable.

5: The electrical cable preparation device of claim 4, wherein the gripper is directly coupled to the housing and is configured to directly couple to the electrical cable, wherein the housing is directly coupled to the guide rail, and wherein the guide rail is directly coupled to the rotatable tool head and is further configured allow the rotatable tool head to rotate about the electrical cable within the housing.

6: The electrical cable preparation device of claim 1, wherein the gripper is a first gripper positioned at a proximal end of the housing, the housing further comprising a second gripper positioned at a distal end of the housing, wherein the second gripper is configured to couple the rotatable tool head to the electrical cable.

7: The electrical cable preparation device of claim 1, wherein the housing comprises an opening configured to allow cutting debris to be removed from the electrical cable preparation device.

8: The electrical cable preparation device of claim 1, further comprising a camera configured to output image data representing one or more images of the electrical cable.

9: The electrical cable preparation device of claim 1, wherein the rotatable tool head is configured to operate hands-free.

10: The electrical cable preparation device of claim 1, wherein a maximum cross-sectional dimension of the cable preparation device in a direction perpendicular to a longitudinal axis of the electrical cable is less than seven inches.

11: The electrical cable preparation device of claim 1, wherein the electrical cable preparation device is configured to couple to the electrical cable and operate without removing the electrical cable from an electrical cabinet housing the electrical cable.

12: The electrical cable preparation device of claim 1, further comprising an axial driver configured to move the rotatable tool head axially along a longitudinal axis of the electrical cable.

13: The electrical cable preparation device of claim 1, wherein the plurality of rollers are configured to move symmetrically in a radial direction relative to a center axis of the electrical cable.

14: The electrical cable preparation device of claim 13, wherein the plurality of rollers are configured to move symmetrically relative to one another by being mechanically coupled to one another.

15: The electrical cable preparation device of claim 1, wherein the at least one cutting tool comprises at least one spring loaded cutting tool.

16: The electrical cable preparation device of claim 1, wherein the at least one cutting tool includes a first cutting tool configured to remove a jacket layer of the electrical cable and a second cutting tool configured to remove an insulation layer of the electrical cable.

17: The electrical cable preparation device of claim 16, wherein the first cutting tool and the second cutting tool are identical.

18: The electrical cable preparation device of claim 16, further comprising a second depth driver configured to insert into the rotatable tool head to adjust a pitch of the first cutting tool.

19: The electrical cable preparation device of claim 17, wherein the first cutting tool comprises a cutting blade extending substantially vertically and a positioning and lifting blade extending substantially horizontally.

20: A method comprising:
installing, by an operator, an electrical cable preparation device onto an electrical cable; and
removing, but the electrical cable preparation device, a layer of the electrical cable,
wherein the electrical cable preparation device comprises:
a rotatable tool head comprising:
a plurality of rollers; and
at least one cutting tool;
a depth driver configured to insert into the rotatable tool head to adjust a radial depth of the plurality of rollers or a radial depth of the at least one cutting tool;
a housing configured to house the rotatable tool head and to allow the rotatable tool head to rotate about an electrical cable and move axially along the electrical cable; and
a gripper configured to couple the housing to the electrical cable, wherein the gripper is configured to prevent the housing from rotating or moving axially relative to the electrical cable.

21: The method of claim 21, wherein installing the electrical cable preparation device comprises:
positioning, by the operator, the electrical cable preparation device onto the electrical cable; and
gripping, by the gripper, the electrical cable.

22: The method of claim 20, wherein the gripper is configured to be at least one of manipulated by the operator to grip the electrical cable or to grip the electrical cable in response to a command received from a computing device.

23: The method of claim 20, further comprising:
positioning, by the electrical cable preparation device, the rotatable tool head of the electrical cable preparation device at an end of an electrical cable;
adjusting, by the electrical cable preparation device, a radial depth of at least one cutting tool of the rotatable tool head to a preprogrammed cutting depth; and
rotating, by the electrical cable preparation device, the rotatable tool head with the at least one cutting tool at the predetermined cutting depth.

24: The method of claim 23, further comprising rotating, by the electrical cable preparation device, the at least one cutting tool to a predetermined pitch.

25: The method of claim 23, wherein adjusting the radial depth of the at least one cutting tool comprises:
inserting, by the electrical cable preparation device, the depth driver into the rotatable tool head to engage a radial depth adjusting mechanism of the rotatable tool head; and
rotating, by the electrical cable preparation device, the depth driver to adjust the radial depth of the at least one cutting tool.

26: The method of claim 23, further comprising:
inserting, by the electrical cable preparation device, the at least one cutting tool of the rotatable tool head of the electrical cable preparation device into at least one layer of the electrical cable to a predetermined depth;
rotating, buy the electrical cable preparation device, the at least one cutting tool to a predetermined pitch; and
rotating, by the electrical cable preparation device, the rotatable tool head to create a spiral cut through at least one layer of the electrical cable.

27: The method of claim 26, wherein performing a spiral cut comprises:
while rotating the rotatable tool head about the electrical cable with the at least one cutting tool at the predetermined depth, moving, by an axial driver, the rotatable tool head longitudinally along a guide rail,
wherein the gripper is directly coupled to a housing configured to house the rotatable tool head, wherein the housing is directly coupled to the guide rail, and wherein the guide rail is directly coupled to the rotatable tool head.

28: The method of claim 27, further comprising:
holding, by the gripper, the housing and guide rail to be stationary relative to the electrical cable as the rotatable tool head is at least one of rotating about the electrical cable or moving longitudinally along the guide rail.

29: An electrical cable preparation system configured to remove one or more layers of an electrical cable, the electrical cable preparation system comprising:
a rotatable tool head comprising:
a plurality of rollers; and
at least one cutting tool;
a depth driver configured to insert into the rotatable tool head to adjust a radial depth of the plurality of rollers or a radial depth of the at least one cutting tool;
a housing configured to house the rotatable tool head and to allow the rotatable tool head to rotate about an electrical cable and move axially along the electrical cable; and
a gripper configured to couple the housing to the electrical cable, wherein the gripper is configured to prevent the housing from rotating or moving axially relative to the electrical cable; and
a computing device comprising processing circuitry configured to:
position the rotatable tool head of the electrical cable preparation device at an end of an electrical cable;
adjust a radial depth of at least one cutting tool of the rotatable tool head to a preprogrammed cutting depth; and
rotate the rotatable tool head with the at least one cutting tool at the predetermined cutting depth.

30: The electrical cable preparation system of claim 29, wherein the processing circuitry is further configured to cause the gripper to grip the electrical cable after the rotatable tool head is positioned on the electrical cable.
